(19) United States
(12) Patent Application Publication
(10) Pub. No.: US 2019/0238708 A1
(43) Pub. Date: Aug. 1, 2019

(54) SYSTEM AND METHOD FOR MONITORING AND OPTIMIZING A DOCUMENT CAPTURE SYSTEM

(71) Applicant: OPEN TEXT CORPORATION, Waterloo (CA)

(72) Inventors: Vitaly Stanislavovitch Kozlovsky, Saint-Petersburg (RU); Mikhail Yunevitch Zakharov, Saint-Petersburg (RU); Aleksandr Yevgenyevitch Maklakov, Saint-Petersburg (RU); Alexey Vyatcheslavovitch Petrochenko, Saint-Petersburg (RU)

(21) Appl. No.: 16/259,663

(22) Filed: Jan. 28, 2019

(30) Foreign Application Priority Data
Jan. 29, 2018 (RU) 2018103207

(51) Int. Cl. H04N 1/00; G06F 11/30; G06F 11/34; G06F 16/93; G06F 8/61

(52) U.S. Cl. CPC H04N 1/00949; G06F 11/3013; G06F 11/3452; H04N 1/00408; G06F 8/61; H04N 1/00323; G06F 16/93

(57) ABSTRACT

Systems and methods for optimizing digital document capture processes are disclosed. One embodiment is a system a network, a document processing system coupled to the network, the document processing system configured with a plurality of configurable code modules executable to execute a compiled capture process that implements a capture flow to convert source documents into document images and associated document attributes, the document processing system. The document processing system comprises a processor coupled to a communications interface and a non-transitory computer readable medium coupled to the processor, the non-transitory computer readable medium storing a set of computer executable instructions comprising instructions executable to monitor a machine executing the compiled capture process to collect performance statistics related to execution of the compiled capture process and apply defined capture flow optimization rules to the performance statistics and generate and output runtime environment recommendations based on the application of the rules.

### TECHNICAL FIELD

The present disclosure is related to systems for capturing documents and converting the documents into images and related data. Even more particularly, embodiments are related to systems and methods for monitoring and optimizing document capture systems.

### BACKGROUND

Document capture solutions use capture processes to convert information from source documents, such as printed documents, faxes, and email messages, into digitized data, and to store the data and images into back-end systems for fast and efficient data retrieval. These solutions can help take control of large volumes of structured, unstructured, and semi-structured data and transform critical documents into process-ready digital content that can be integrated with broader, computer-facilitated, processes of an organization.

A number of document capture solutions provide process design tools that allow users to design and deploy capture processes having multiple steps. A process design tool may provide a graphical user interface that allows a user to graphically design capture processes, from capturing of the documents to delivering the documents to a destination content repository or other target system. In some implementations, when the user indicates that he or she is satisfied with a capture process design, the process design tool compiles the design into a capture process used by a computer system to capture and process documents.

A capture process may have a complicated flow with multiple branches and steps. In practice, this can lead to the process design tool compiling a process with redundant or unnecessary steps, resulting in an inefficient use of computer resources.

As an additional source of inefficiencies, it can be difficult during process design for the user to predict the number of processing instances that should be allocated for run-time conditions. As a consequence, the user may design a capture process that results in bottlenecks or other inefficiencies during runtime. A poorly designed capture process may further lead to system inefficiencies when the capture process is integrated into a larger process, such as a business process.

### SUMMARY

Systems and methods for optimizing digital document capture processes are disclosed. A system of one or more computers can be configured to perform particular actions by virtue of having software, firmware, hardware, or a combination of them installed on the system that in operation causes the system to perform the operations or actions. One or more computer programs can be configured to perform particular operations or actions by virtue of including instructions that, when executed by data processing apparatus, cause the apparatus to perform the operations or actions.

One general aspect includes a system comprising a communication interface, a processor coupled to the communications interface, and a computer readable medium coupled to the processor. The computer readable medium stores a set of computer executable instructions that include instructions executable by the processor to execute a compiled capture process to convert source documents into document images and associated document attribute, the compiled capture process implementing a capture flow, monitor the performance of a capture system machine executing the compiled capture process to collect performance statistics, apply capture flow optimization rules to the performance statistics and generate runtime environment recommendations based on the application of the rules.

Another general aspect includes a system including: a network; a document processing system coupled to the network, the document processing system configured with a plurality of configurable code modules executable to execute a compiled capture process that implements a capture flow to convert source documents into document images and associated document attributes, the document processing system including: a communications interface, a processor coupled to the communications interface and a non-transitory computer readable medium coupled to the processor. The non-transitory computer readable medium may a set of computer executable instructions including instructions executable to: monitor a machine executing the compiled capture process to collect performance statistics related to execution of the compiled capture process; and apply defined capture flow optimization rules to the performance statistics and generate and output runtime environment recommendations based on the application of the rules.

According to one embodiment, the set of computer executable instructions includes instructions executable to: determine a central processing unit (CPU) usage that occurred during execution of the compiled capture process and generate a recommendation to add an addition CPU based on the determined CPU usage. More particularly, according to one embodiment, the CPU usage is based on amount of time a software component executed in an elapsed time.

The performance statistics may include a task queue length for a corresponding module of the plurality of configurable code modules. The set of computer executable instructions may include instructions executable to generate a recommendation to install additional instances of a module type of the corresponding module based on a determination that the task queue length exceeded a threshold. The set of computer executable instructions may include instructions executable to generate a recommendation to add additional operators based on a determination that the task queue length exceeded a threshold.

The computer executable instructions may be further executable to recommend a change to the capture flow based on the application of the defined capture flow optimization rules to the performance statistics. The system may access historical batch data created during execution of the compiled capture process. The system may also identify a loop back to a decision where the loop includes a step that corresponds to a module that requires operator input to complete a task. The system may also determine a number of documents that looped through the loop during execution of the compiled capture process, a loop decision input step processing time for a loop decision input step and a loop processing time. The system may also determine whether execution of the compiled capture process would have been more efficient had an output of a step prior to a loop decision input step been connected to a loop step based on the loop decision input step processing time, loop processing time and the number of documents that looped through the loop. The system may also generate a recommended change to the capture flow based on a determination that execution of the compiled capture process would have been more efficient had the output of the step prior to the loop decision input step been connected to the loop step. The system may also present the recommended change in a graphical representation of the capture flow. Presenting the recommended change in the graphical representation of the capture flow may include presenting a representation of a recommended path from the step prior to the loop decision input step to the loop step. The system the set of computer executable instructions may further include instructions executable to recompile the capture flow using the recommended path and redeploy the capture flow to the document processing system. Implementations of the described techniques may include hardware, a method or process, or computer software on a computer-accessible medium.

Another general aspect includes a computer program product including a non-transitory computer readable medium storing a set of computer executable instructions, the set of computer executable instructions including instructions executable to: monitor, during execution of a compiled capture process that implements a capture flow to convert source documents into document images and associated document attributes, a machine of a document processing system configured with a plurality of configurable code modules executable to execute the compiled capture process to collect performance statistics related to execution of the compiled capture process. The computer program product also includes apply defined capture flow optimization rules to the performance statistics and generate and output runtime environment recommendations based on the application of the rules. Other embodiments of this aspect include corresponding computer systems, apparatus, and computer programs recorded on one or more computer storage devices, each configured to perform the actions of the methods.

Various embodiments may include one or more of the following features. The computer program product where the set of computer executable instructions includes instructions executable to: determine a central processing unit (CPU) usage that occurred during the execution of the compiled capture process and generate a recommendation to add an additional CPU based on the determined CPU usage. The computer program product where the performance statistics include an amount of time a software component executed in an elapsed time. The computer program product where the performance statistics includes a task queue length for a corresponding module of the plurality of configurable code modules and where the set of computer executable instructions includes instructions executable to generate a recommendation to install additional instances of a module type of the corresponding module based on a determination that the task queue length exceeded a threshold. The computer program product where the performance statistics includes a task queue length for a corresponding module of the plurality of configurable code modules and where the set of computer executable instructions includes instructions executable to generate a recommendation to add additional operators based on a determination that the task queue length exceeded a threshold. The computer program product where the set of computer executable instructions are further executable to recommend a change to the capture flow based on the application of the defined capture flow optimization rules to the performance statistics. The computer program product where the set of computer executable instructions are further executable to: access historical batch data created during execution of the compiled capture process; identify a loop back to a decision that includes a step that corresponds to a module that requires operator input to complete a task; determine a number of documents that looped through the loop during execution of the compiled capture process, a loop decision input step processing time for a loop decision input step and a loop processing time; determine whether execution of the compiled capture process would have been more efficient had an output of a step prior to a loop decision input step been connected to a loop step based on the loop decision input step processing time, loop processing time and the number of documents that looped through the loop; based on a determination that execution of the compiled capture process would have been more efficient had the output of the step prior to the loop decision input step been connected to that loop step, generate a recommended change to the capture flow that was compiled into the compiled capture process; present the recommended change in a graphical representation of the capture flow. The computer program product where presenting the recommended change in the graphical representation of the capture flow includes presenting a representation of a recommended path from the step prior to the loop decision input step to the loop step. The computer program product where the set of computer executable instructions are further executable to recompile the capture flow and deploy the capture flow to the document processing system. Implementations of the described techniques may include hardware, a method or process, or computer software on a computer-accessible medium.

Another general aspect includes a system including: a network; a document processing system coupled to the network, the document processing system configured with a plurality of configurable code modules executable to execute a compiled capture process that implements a capture flow to convert source documents into document images and associated document attributes. The document processing system may include a communications interface, a processor coupled to the communications interface and a non-transitory computer readable medium coupled to the processor. The non-transitory computer readable medium may store a set of computer executable instructions including instructions executable to: monitor a machine executing the compiled capture process to collect performance statistics related to execution of the compiled capture process; traverse the compiled capture process to identify a decision branch that creates a loop that includes a step that corresponds to a configurable code module that requires operator input to complete a task; determine, based on the collected performance statistics, whether execution of the compiled capture process would have been more efficient had an output of a step prior to a loop decision input step been connected to a loop step; based on a determination that the compiled capture process would have been more efficient had the output of a step prior to the loop decision input step been connected to the loop step, generate a recommended change to the capture flow; present the recommended change in a graphical representation of the capture flow. Other embodiments of this aspect include corresponding computer systems, apparatus, and computer programs recorded on one or more computer storage devices, each configured to perform the actions of the methods.

Various embodiments may include one or more of the following features. The system where the set of computer executable instructions includes instructions executable to determine a number of documents that looped through the loop during execution of the compiled capture process, a loop decision input step processing time for a loop decision input step and a loop processing time and the determination is based on the number of documents that looped through the loop during execution of the compiled capture process, the loop decision input step processing time for the loop decision input step and the loop processing time. The system where presenting the recommended change in the graphical representation of the capture flow includes presenting a representation of a path from the step prior to the loop decision input step to the loop step. The system where the set of computer executable instructions further includes instructions executable to recompile the capture flow and deploy the capture flow to the document processing system. Implementations of the described techniques may include hardware, a method or process, or computer software on a computer-accessible medium.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram illustrating stages of an embodiment of a flow to capture data.

FIG. 2 illustrates an example of one embodiment of processing a document page image.

FIG. 3 is a block diagram illustrating an embodiment of a document processing system.

FIG. 4 is a diagrammatic representation of one embodiment of components of a document capture platform.

FIG. 5 is a diagrammatic representation of one embodiment of a system for designing and deploying a capture process.

FIG. 6A illustrates one embodiment of a first portion of an interface for designing a capture flow and FIG. 6B illustrates one embodiment of a second portion of an interface for designing a capture flow.

FIG. 7A illustrates one embodiment of a portion of an original capture flow.

FIG. 7B illustrates one embodiment of a graph representing the original capture flow.

FIG. 7C illustrates on example of an optimized capture flow.

FIG. 8 illustrates one embodiment of a method for processing a capture flow.

FIG. 9A is a flow chart illustrating one embodiment of a document flow according to various embodiments. FIG. 9B is a flow chart illustrating example recommended changes to the document flow according to various embodiments. FIG. 9C is a flow chart illustrating another example of recommended changes to the document flow according to various embodiments. FIG. 9D is a flow chart illustrating another example of recommended changes to the document flow according to various embodiments.

FIG. 10 is a flow chart illustrating one embodiment of a method for optimizing a document flow based.

FIG. 11 is a diagrammatic representation of one embodiment of a distributed network computing environment.

### DETAILED DESCRIPTION

Various embodiments are illustrated in the figures, like numerals being generally used to refer to like and corresponding parts of the various drawings. Descriptions of well-known starting materials, processing techniques, components and equipment are omitted so as not to unnecessarily obscure the invention in detail. It should be understood, however, that the detailed description and the specific examples, while indicating preferred embodiments of the systems and methods, are given by way of illustration only and not by way of limitation. Various substitutions, modifications, additions and/or rearrangements within the spirit and/or scope of the underlying inventive concept will become apparent to those skilled in the art from this disclosure.

Systems and methods for optimizing digital document capture processes are disclosed. In various embodiments, a design tool is provided that allows a user to design a capture flow. When the user is satisfied with the capture flow, a capture flow compiler (“CF compiler”) compiles the capture flow into instructions usable by a capture system to implement the capture flow. Embodiments may include a capture flow advisor tool that is configured to receive statistics and create recommendations to particular capture flow changes or recommend patterns to be applied by a designer who creates or modifies the capture flow. Recommendations may include recommendations to change the execution environment such as, allocating more or fewer worker module instances, upgrading or reconfiguring hardware/virtual environment of operating system in which worker modules execute. Recommendations may be output to a user via graphical user interface, email message or other mechanism.

Embodiments may further include an automated integrated process advisor. The integrated process advisor tool can summarize the capture flow process output statistics and create recommendations with respect to a process into which the capture process is integrated.

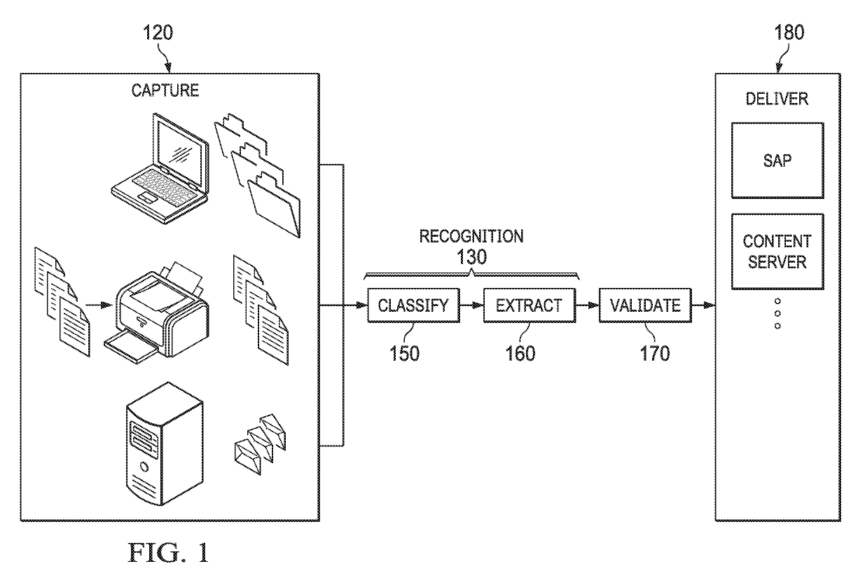

FIG. 1 is a block diagram illustrating stages of an embodiment of a flow to capture data. In capture stage 120, documents from a variety of sources including scanners, fax server, email servers, file systems, web services and other sources are captured. In the example shown, electronic documents are imported from a file system, hard copy documents are scanned and transformed into digital content (e.g., by scanning the physical sheet(s) to create a scanned image) and emails captured. In a recognition stage 130, text, machine markings or other data within an image is identified and extracted. In one embodiment, recognition stage 130 can include a classify stage 150 and an extraction stage 160. In classify stage 150, automated classification technology identifies different document types through a combination of text- and image-based analysis. In some embodiments, classification includes detecting a document type corresponding to an associated data entry form. At extraction stage 160, data is extracted from the digital content, for example through optical character recognition (OCR) and/or optical mark recognition (OMR) techniques. Extracted data is validated at validation stage 170. In various embodiments, validation may be performed at least in part by an automated process, for example by comparing multiple occurrences of the same value, by performing computations or other manipulations based on extracted data and other data. Automated validation may involve integration with another data source, usually a database or enterprise application such as ERP. In various embodiments, all or a subset of extracted values, (e.g., those for which less than a threshold degree of confidence is achieved through automated extraction and/or validation), may be validated manually by a human indexer or other operator. Once all data has been validated, output is delivered at delivery stage 180. During delivery, data and document images are exported and made available to other content repositories, databases, and business systems in a variety of formats.

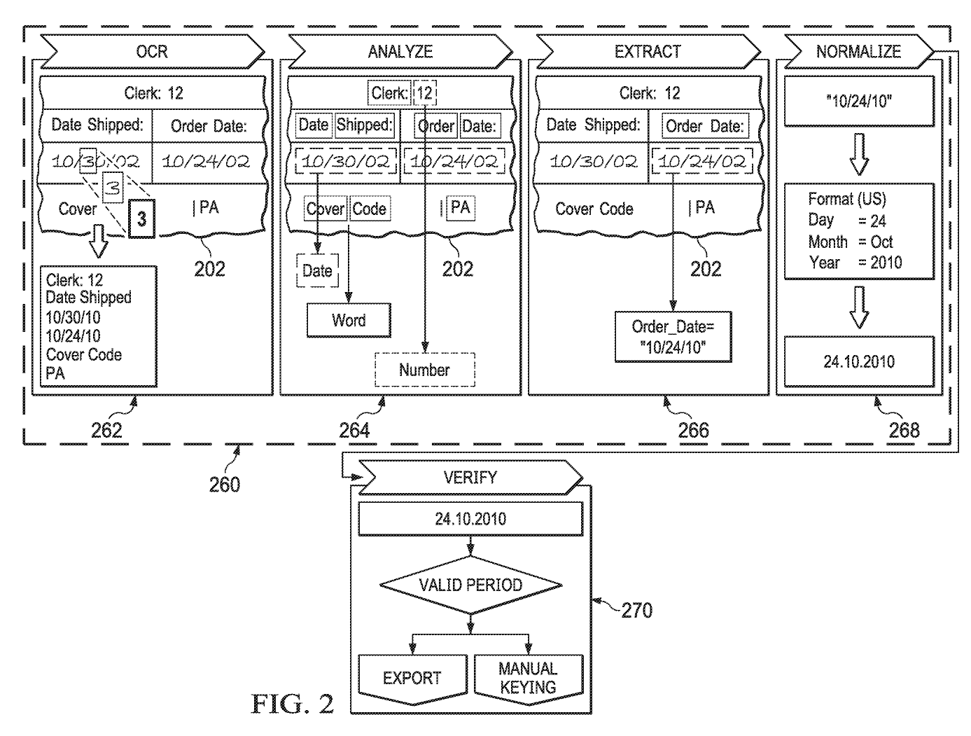

Each stage may include a number of steps. FIG. 2 illustrates an example of one embodiment of processing a page image 202 through an extraction stage 260 and validation stage 270. The image 202 may have been captured and classified in prior stages. Extraction stage 260 may include an OCR step 262 to turn pixels in an image 202 into characters. It can be noted that, in some embodiments, the image 202 may be classified as being of a particular document type and the OCR step 262 may, based on the document type, be configured to perform OCR on specific zones in the image. In other embodiments, the OCR step 262 may perform whole page recognition. Extraction stage 260 may further include an analyze step 264 in which rules are applied to the recognized text to identify and tag meaningful entities. In an extract step 266, rules are applied to extract particular data among alternatives. For example, the extract step may apply rules to extract a particular date entry from among several detected date entries. A normalization step 268 may normalize data into a format used by subsequent processing in a capture system. For example, a string may be decomposed into subunits and reformatted according to rules.

FIG. 2 further illustrates a validation stage 270. In the validation stage, extracted data is checked against validation rules. Validated data can proceed to a delivery stage for export. In some cases, data that cannot be validated can be forwarded to an operator for manual keying (manual indexing of values).

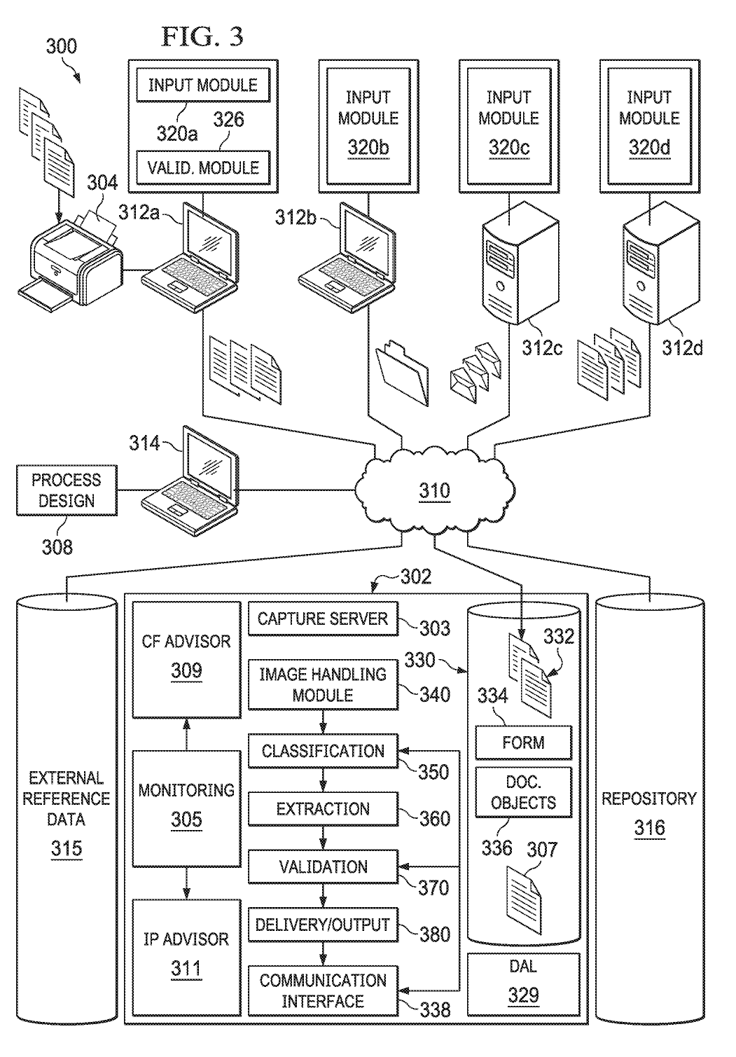

FIG. 3 is a block diagram illustrating an embodiment of a document processing system 300. In the example shown, system 300 comprises a document capture system 302 communicatively coupled to capture system clients 312a, 312b, 312c, 312d (generally referred to as capture system clients 312), a process designer operator system 314, an external reference data source 315 and a destination repository 316 by a network 310. Document capture system 302 and capture system clients 312 execute configurable code components to provide a system that implements a process to convert information from printed documents, faxes, email messages or other documents into digitized data, and to store the data and images into back-end systems for fast and efficient data retrieval.

In a capture stage, system 300 captures paper, faxes, film, images, or imported electronic documents (structured and unstructured) through fax, scanner, network drives, remote sites, via web services or other sources. According to one embodiment, capture system clients 312a, 312b, 312c, and 312d can execute respective input modules 320a, 320b, 320c, 320d (referred to generally as input modules 320) to capture documents and send document images and associated attribute values to capture system 302. Input modules 320 may capture documents having a variety of formats. In the embodiment of FIG. 3, for example, a capture system client 312a is attached to a scanner 304 that can generate images of document pages. An input module 320a can thus be configured to capture images of documents via scanner 304 and provide an interface that allows an operator to perform operations on the images, input associated attributes or perform other actions. Input module 320a sends the resulting document data (for example, page images, operator entered attribute values, system generated attribute values) to document capture system 302 for processing. Further in FIG. 3, input module 320b is configured to generate images of documents in a file system or capture documents of particular file types and send the document data to document capture system 302 for processing. Input module 320c collects images of emails from an email server and sends the emails to document capture system 302 for processing. Input module 320d provides a web service input module that can receive information necessary to retrieve documents via a web service, collect the documents via the web service and provide the documents to document capture system 302.

Document capture system 302 includes a document capture system repository 330, which may comprise an internal file system, network file system, internal database or external database or other type of repository or combination thereof. Document data is received and stored in a capture store 332 in a document capture system repository 330. In some embodiments, document data is received in batches. According to one embodiment, system 302 includes a data access layer (DAL) 329. The DAL 329 is the programming layer that provides access to the data stored in the various repositories and databases used by capture system 302. For example, the DAL 329 can provide an API that is used by modules to access and manipulate the data within the database without having to deal with the complexities inherent in this access.

Document capture system 302 further classifies received documents. For example, document capture system 302 may identify documents based on document type so that documents are routed to the appropriate data extraction process. Document capture system 302, in an extraction stage, performs OCR to extract machine and handprint text. Document capture system 302 may use zonal OCR for structured documents and full-text OCR for unstructured documents. Document capture system 302 may also perform OMR to recognize bar codes and other data. The extracted data may be stored in a structured representation.

Extracted data can be validated in a validation stage. Data validation may be performed, at least in part, by document capture system 302 by accessing external data from external reference data source 315 via a network 310. For example, document capture system 302 may validate data formulas against an external database or custom business rules using scripting events. As another example, an external third party database that associates street addresses with correct postal zip codes may be used to validate a zip code value extracted from a document. In various embodiments, all or a subset of extracted values, (e.g., those for which less than a threshold degree of confidence is achieved through automated extraction and/or validation), may be validated manually by a human indexer or other operator using a user interface configured to support validation.

In some embodiments, once validation has been completed the resulting raw document image and/or form data are delivered as output, for example by storing the document image and associated data in a destination repository 316, such as an enterprise content management (ECM) or other repository. Document information can be stored as images, text, or both. In some embodiments, document capture system 302 supports conversion to PDF, full-text OCR, and PDF compression.

Document capture system 302 may execute various code components to process the document images received from input modules 320 through various stages. According to one embodiment, document capture system 302 includes a capture server 303 to manage processing of documents and set of production modules to process the documents. The capture server 303 maintains consistency of processing a capture flow, sets tasks, orders and routes documents (document images and associated data) to pass documents to the production modules of the capture system 302. In the illustrated embodiment, the production modules include image handling module 340, classification module 350, extraction module 360, validation module 370 and delivery/output module 380.

According to one embodiment, an image handling module 340 enhances document images for subsequent recognition steps. Document image data, potentially enhanced by an image handling module 340, is provided to a classification module 350 that uses data forms 334 to classify each document by type and create an instance of a type-specific object 336 (e.g., a form instance) for an identified document. The object instance 336 may reference the associated image. In some cases, document capture system 302 may provide an interface to enable an operator to confirm or update the document identification.

Data extraction module 360 uses OCR, OMR, and/or other techniques to extract data values from the document image and uses the extracted values to populate the corresponding document type object instance, which may be persisted in repository 330. For example, data extraction module 360 may extract field data from a document image into the document type object instance for a data entry form. Thus, in some embodiments a document is classified by type and an instance of a corresponding data entry form is created and populated with data values extracted from the document image.

Data extraction module 360 may provide a score or other indication of a degree of confidence with which an extracted value has been determined based on a corresponding portion of the document image. In some embodiments, for each data entry form field, a corresponding location within the document image from which the data value entered by the extraction module in that form field was extracted, for example the portion that shows the text to which OCR or other techniques were applied to determine the text present in the image, is recorded.

Data extraction module 360 provides a populated document type object instance (e.g., a populated data entry form) to a validation module 370 configured to perform validation. The validation module 370 applies validation rules, such as restriction masks, regular expressions, and numeric only field properties, to validate data. The validation module 370 may communicate via a communications interface 338, for example a network interface card or other communications interface, to obtain external data to be used in validation.

In some embodiments, the validation module 370 applies one or more validation rules to identify fields that may require a human operator to validate. The validation module 370 may communicate via communications interface 338 to provide to human indexers via associated client systems, such as one or more of clients 312, tasks to perform human/manual validation of all or a subset of the extracted data. Validation may thus be performed at least in part based on input of a plurality of manual indexers each using an associated client 312 to communicate via network 310 with document capture system 302. Document capture system 302 may be configured to queue validation tasks and to serve tasks out to indexers using clients 312. Clients 312 may include browser-based or installed client software that provides functionality to allow an operator to validate data (e.g., operator validation module 326).

According to one embodiment, the validated data is provided to a delivery/output module 380 configured to provide output via communication interface 338, for example by storing the document image and/or extracted data (e.g., structured data as captured using a corresponding data entry form or other object instance) in an enterprise content management system or other repository.

Document capture system 302 processes a compiled capture process 307 to convert information received from input modules 320, into digitized data, and to store the data and images into back-end systems, such as destination repository 316, for fast and efficient data retrieval. Process designer operator system 314 is an operator machine that runs a process design tool 308 that allows a designer to design a capture flow. The design tool 308 includes a capture flow compiler (“CF compiler”) to compile the capture flow into capture process 307 that defines the processing steps for processing document images, the order in which the steps are applied and what to do with the resulting images and data. According to one embodiment, capture process 307 provides instructions to document capture system 302 on the various types of modules to use, how they are configured, the order in which to use them.

Document capture system 302 may store multiple capture processes 307 that comprise instructions for processing batches of documents. In this context, a “batch” is a defined group of pages or documents to be processed as a unit using a set of instructions specified in a capture process 307. For example, a batch may start as a stack of paper that gets scanned into the system and converted to image files that are processed as a unit. Batches, however, can also be created using data from various other sources. Batches may be created using administrative tools or by input modules 320. In some embodiments, the identity of the capture process 307 to be used to process a batch may be configured at setup in the input module 320. In other embodiments, the input module 320 may allow the operator to select the capture process 307 when creating the batch. Document capture system can route the batch data from module to module as determined by the processing instructions of a process 307.

A module may process all of the batch data at once or the batch data may be separated into smaller work units. For example, according to one embodiment, each original page becomes a node in the batch. Pages can be grouped and organized into a tree structure having a plurality of levels. For example, if eight levels are used, the pages themselves are at level 0 (the bottom), and the batch as a whole is at level 7 (the top). Levels 6-1 may represent groupings and sub-groupings of pages (e.g., analogous to a folder structure). Modules can process data at any level of the tree, as specified by the process 307.

In one embodiment, the production modules process tasks. A task is a unit of work processed by a production module. A task may comprise, for example, the data to be processed, processing instructions, and an identification so that the capture system 302 knows which batch the task belongs to when the production module returns it. Tasks may be associated with a node and step. As discussed below, a step can comprise a configuration of a module specified within a process 307. A single process 307 may contain multiple steps using the same module.

The size of a task can vary depending on the module's trigger level. Using the example of a system in which pages are grouped and organized into a tree structure discussed above, a level 0 task contains the data from a single page; a level 1 task contains the data from a document, which may hold several pages; a level 7 task contains the data from all the pages in an entire batch.

At a particular moment, a task can be in any one of a number of states. Example states include, but are not limited to, Not Ready, Ready, Working, Done, Sent, Offline, or TaskError. In one embodiment, capture system 302 only sends Ready tasks to production modules. The state of a task is manipulated by capture system 302 as well as by the modules that process it.

According to one embodiment, batches are created by the capture system 302 and stored at the capture system computer storage. The server 303 controls batch processing, forms the tasks and routes them to available production modules based on the instructions contained in the process 307.

Capture system 302 can queue tasks (e.g., at the capture server machine). In some embodiments, tasks are processed according to their priority. The batch priority can be defined by the process settings when the batch is created. If not specified, a default priority is set. Rules may be applied to determine the order of processing of batches with the same priority. For example, batches that have the same priority may be processed according to creation date and time.

Capture system 302 monitors the production modules and sends them tasks from open batches. If multiple machines are running the same production module, the server can apply rules to send the task to a particular instance. For example, the server can send the tasks to the first available module. The batch node used by the task may be locked when it is being processed and is unavailable to other modules.

When the capture system 302 receives the finished task, capture system 302 can include the batch node of that task in a new task to be sent to the next module as specified in the process 307. Capture system 302 can also send a new task to the module that finished the task if there are additional tasks to be processed by that module. If no modules are available to process the task, then system 302 queues the task until a module becomes available. According to one embodiment, server 303 and the production modules work on a “push” basis.

Each task for a process 307 may be self-contained so modules can process tasks from any batch in any order. According to one embodiment, the capture system 302 tracks each task in a batch and saves the data generated during each step of processing. This asynchronous task processing means that the modules can process tasks as soon they become available, which minimizes idle time.

According to one embodiment, attributes are used to store various types of information and carry information from module to module. Attributes can also control when and how tasks are processed.

Attributes can hold pointers to the input or output files a module creates, receives, or sends within a task. The files may be stored by system 302 along with other files. Input and output file values can be used to “connect” module steps together. For example, for a simple process with a scan input module 320a and an image handling module 340, the capture process 307 can set an InputImage value of the image handling module 340 equal to an output image value of the scan input module 320a.

Attributes may hold trigger values that are used to kick off processing when specific conditions are met. Trigger values can signal the capture system 302 to send a task to a module for processing. A trigger value may indicate a trigger level. For example, process 307 can specify that a delivery module 380 triggers at level 7 and uses the value of InputImage attribute as a trigger. In this example, when an upstream module finishes processing tasks and all the InputImage attributes for pages in a batch are set to non-zero data values, capture system 302 can send a task to the delivery module 380 to start batch processing the batch because the trigger condition has been met.

Attribute values may hold module step configuration and setup values, such as scanner settings, image settings, OCR language settings, index field definitions, and others. The settings can potentially change for every task the module processes. For example, assume ten machines that are running validation modules 370 that are all configured to accept tasks from any batches being processed. Since the tasks from different batches can have different index fields, the settings needed for each task received are potentially different. The capture system 302 can send a validation module setup attribute values in the task so that the validation module displays the correct set of index fields for each task it receives.

Attributes can hold all of the metadata that results from processing tasks in each module. For example, modules may have attributes that hold the date and time an image was scanned, operator name of the operator who scanned the image, and elapsed time to process a task. Specific modules can also have attributes for index field contents, OCR results, and error information or other information. Thus, attributes can store various statistics generated by a module during processing. A module may output performance statistics for tasks, such as task start date and time, end date and time, total time, error number, error text or other statistics. The statistics output by a module may include operator statistics, such as how long it took an operator to perform an operation on an image (e.g., time spent per image, typing speed when indexing fields, the number of manually classified documents or other operator statistics).

Attributes can hold information such as batch name, ID, description, priority, and process name.

Attributes can hold user preferences, hardware configurations, machine names, and security. In most cases, system values are global in scope and do not apply to tasks contained within a batch. System values may be referenced by strings and include: $user, $module, $screen, $machine, and $server. For example, when a module stores a file that is not associated with a particular batch or process, it may use the “$module” key to store and retrieve the file from the system 302. An example of this type of file is an OCR spell-checking dictionary.

Production attributes are attributes that a module exposes to other modules. According to one embodiment, modules expose their production attributes by declaring them in a Module Definition File (MDF) (for example, a text file that contains a declaration for each defined attribute). Production attributes may include task-related input and output file values, module data values, statistical values or other values. When a process 307 is defined, the MDFs (or other declaration of attributes) of the modules used in that process may be included. In some embodiments, the MDF (or other declaration of attributes) can declare the statistics to be collected during processing (e.g., start date and time, end date and time, total time, error number, error text, operator statistics or other statistics). Consequently, all of the attributes in the MDFs (or other declaration) are available to the process code and the process code can use the attribute values as needed. Each module can refer to the production attribute values of all the other production modules referenced in a process 307 being implemented.

Attribute values can be of various data types, including, but not limited to: String, Long, Double, Date, Boolean, Object, or File. Attribute are declared as input or output values (or both at once) to indicate if the module uses the attribute value as an input or outputs a value for the attribute. Attribute values can also be declared as trigger values. According to one embodiment, any trigger declared for a module is only used as a trigger if it is referenced in the process 307. Referenced trigger values can be initialized with data before the module processes the task with which the values are associated. Production attribute values can be associated with a particular node level.

Different classes of modules may declare different types of production attributes. For example:
Task creation modules: The first module in a process that creates batches from a specified process and starts a document capture job. Typically, task creation modules can also open existing batches when necessary. Examples of creation modules include input modules 320 (e.g., scan modules, web services input modules, file system import modules, email import modules or other modules). According to one embodiment, these modules may, in some circumstances, not use input attribute values because they do not receive tasks from other modules. However, task creation modules use output attributes for storing data captured during batch processing and statistical data about the batch processing.
Task processing modules: Task processing modules accept tasks from other modules, perform an operation on the data in the tasks, and then send the tasks to other modules. According to one embodiment, task processing modules wait for any task from any batch or open a specific batch to process its tasks. These modules may use input attributes to obtain data from other modules and output attributes to make data available to other modules after the module completes its processing.
Delivery/output modules: Delivery modules obtain the results of document capture jobs and export them into longer-term storage solutions. Depending on the export module, the destination for exported data can be a file system, a batch, or a third-party repository. Modules designed to export directly into a repository can map attribute values to the object model of the target system. Images and data files, statistical data, index values, and bar code values can be mapped to the appropriate objects.

According to one embodiment, capture system 302 maintains data to coordinate capture jobs.

For example, in one embodiment, capture system 302 maintains batch files and stage files in a local or external file system or database (for example, repository 330). A batch file contains the batch tree structure and attribute values for a batch being processed. As batches are processed, attribute values can be updated by capture system 302 with the value data generated by each module.

Stage files store captured data. According to one embodiment, a module is configured to send one or more data files to the server for each page scanned or imported In addition or in the alternative, a module is configured send the one or more data files to the next assigned module in a flow. Thus, in some embodiments, a module may send data files to the next module without the data files going to the server between modules.

A page is defined as a single-sided image. When a physical sheet of paper is scanned in duplex mode, it results in two pages (one for each side). According to one embodiment, one stage file is created for each page scanned or imported. However, some modules create multiple files per page. The type of file in which page data is stored varies depending on the module. Each stage file can be associated with a node and named with the unique node ID. Stage files may also be stored in a manner that identifies the stage at which the file was generated. For example, if a scan input module 320a is the first module, image files that the scan module 320a sends to the capture system 302 are stored with the file extension 1. Stage files from the next module are stored with the file extension 2. Files created by the next module would then be saved with the file extension 3. If the input device outputs multiple streams (for example, a multi-stream scanner that outputs a binary and color image for each page scanned), then each stream can be treated as a stage according to one embodiment. In this example, two sequential file extensions such as 1 and 2 could belong to the same step.

The following example Table 1 illustrates a sample record structure maintained by capture system 302 for a node (page) with ID 23e in a simple linear process consisting of three modules.

TABLE 1

| Module | Attribute Name | Value Data |
|---|---|---|
| Scan Module | OutputImage | <ca: 9c-23e-1 |
| Image Processor | InputImage | <ca: 9c-23e-1 |
| | OutputImage | <ca: 9c-23e-2 |
| Completion | Image | <ca: 9c-23e-2 |

The value data <ca:9c-23e-1 is interpreted as follows:
a. <: Designates a stage file.
b. ca: Identifies a server communication session.
c. 9c: The batch ID.
d. 23e: The node ID.
e. 1: The stage number.

As can be noted from Table 1, the data value for the InputImage attribute of the image processor module in the example flow is the same as the data value of Outputlmage attribute from the scan module. This represents an example in which, according to process 307, the output image stage file from the scan module was used as the input image to the image processor module.

As noted above, capture system 302 may process a capture process 307 that defines the processing steps for processing document images, the order in which the steps are applied and what to do with the resulting images and data. The process may provide an order in which modules are to process the tasks, setup attribute values, trigger values, processing instructions and other information used to configure system 300 to process a batch.

Capture system 302 comprises a monitoring module 305 that monitors the performance of one or more machines providing capture system 302. According to one embodiment, if the components of the capture system are executing on a MICROSOFT WINDOWS platform, the monitoring module may monitor the executing code components of the document capture system using the perfmon.exe executable to collect at least a portion of the performance statistics. Examples of performance statistics that can be collected by monitoring module include, but are not limited to the example statistics included in Table 2 below:

TABLE 2

| Performance | |
|---|---|
| Measure | Description |
| % Load Factor | Percentage of elapsed time that the Data Access Layer spends to execute |
| | requests. |
| | The % Load Factor may exceed 100% if there is more than one CPU. For |
| | example: |
| | 2 CPUs = Maximum load factor 200% |
| | 4 CPUs = Maximum load factor 400% |
| | 8 CPUs = Maximum load factor 800% |
| | For example, if over a 10 second interval, DAL executed for 5 seconds |
| | (regardless of the number of threads), then the % Load Factor is 50% (5 |
| | seconds DAL/10 available seconds * 100). |
| | This same calculation holds true with multiple CPUs and multi-threading. For |
| | example, with 8 CPUs, over a 10 second wall clock interval, there are 80 |
| | seconds of available processing time because each CPU has 10 seconds and |
| | there are 8 CPUs (10 * 8 = 80). Thus, if the DAL is executing on all 8 threads for |
| | all 10 seconds of wall clock time, the % Load Factor is 800% (80 seconds of |
| | DAL execution/10 seconds of wall clock time. |
| Avg. Execution | Average execution time in milliseconds for query and non-query. |
| Time Millisec | |
| Current Connection | Current count of active connections to the database. |
| Count | |
| Data Requests/sec | Number of queries and non-queries per second. |
| Total Connection | Total number of connections since the start of the application. |
| Count | |
| Total Error Count | Total number of errors since the start of the application. |
| Total Non Query | Total number of non-query operations since the start of the application. |
| Command Count | |
| Total Non Query | Total execution time in milliseconds for all non-query operations. |
| Execution Time | |
| MilliSec | |
| Total Query | Total number of query operations since the start of the application. |
| Command Count | |
| Total Query | Total execution time in milliseconds for all query operations. |
| Execution Time | |
| Millisec | |
| Total Row Count | Total number of rows fetched. |
| Authorization | Number of authorization checks performed in a capture process per second. |
| Requests/sec | |
| Number of | Number of authorization requests served by a Security Library per step. |
| authorization | |
| requests | |
| Permission set | Number of seconds it takes a query to retrieve the permission set from the |
| requests/second | security database for a particular user. |
| Total number of | Number of authorization requests served by Security Library (all the steps on the |
| authorization | particular system). |
| requests | |
| Permission | Number of permissions updated in Document Capture system per second. |
| Updates/sec | |
| Batch Loads/sec | Number of batches being loaded into memory per second. |
| Batches Loaded | Number of batches loaded in memory at a given time. This number can less than |
| | or equal to the BatchMaxLoaded value set for a server. |
| Connections | Number of clients connected to the server. |
| Disk Bytes | Number of bytes read from the disk by the server in response to file requests by |
| Read/sec | clients. |
| Disk Bytes | Number of bytes written to the disk by the server in response to files sent from |
| Written/sec | clients. |
| VBA Calls/sec | Number of VBA calls made per second. This includes the Finish and Prepare |
| | events defined in the active batches. |
| Network Bytes | Number of bytes read from the network by the server. |
| Read/sec | |
| Network Bytes | Number of bytes written to the network by the server. |
| Written/sec | |
| Packets | Number of packets received by the server from clients per second. |
| Received/sec | |
| Packets Sent/sec | Number of packets sent to clients by the server per second. |
| Pending I/O | Number of packets waiting to be sent by the server. This number is proportional |
| | to the number of connected clients. |
| Processing | Number of messages actively being processed. |
| Message Count | |
| Total Batch Count | The total number of batches that can be loaded by the server. |
| Total Message | Total backlog of the messages in bytes. Keep-alive (ping) messages between |
| Bytes | clients and server are not included in this count. |
| Total Message | Total number of message objects. This includes message objects in any queue. |
| Count | |
| VBA Message | Number of messages remaining in the VBA thread queue to be processed. |
| Thread Queue | |
| Length | |
| WIP Event Queue | The number of events remaining in the WIP event queue to be sent to the |
| Length | database by the server. |
| WIP Event Queue | The total number of times the WIP event queue has been blocked because the |
| Blocked Count | maximum length has been reached. |
| WIP Event Queue | The total time in milliseconds that the WIP event queue has been blocked. |
| Blocked Time | |
| Stat Event Queue | The number of events remaining in the Report Statistics event queues to be sent |
| Length | to the database. This is the total sum of queue length for all ten Report Statistics |
| | queues. |
| Stat Event Queue | The total number of times that the Report Statistics event queues has been |
| Blocked Count | blocked because the maximum length has been reached. This is the total sum of |
| | blocked count for all ten Report Statistics queues. |
| Stat Event Queue | The total time in milliseconds that the Report Statistics event queue has been |
| Blocked Time | blocked. This is the total sum of blocked time for all ten Report Statistics queues. |
| Misc Event Queue | The number of events remaining in the Misc event queue to be sent to the |
| Length | database. |
| Misc Event Queue | The total number of times the Misc event queue has blocked because the |
| Blocked Count | maximum length has been reached. |
| Throttle DB | The number of DB requests being throttled. |
| requests count | |
| Misc Event Queue | The total time in milliseconds that the Misc event queue has been blocked. |
| Blocked Time | |
| Heavy DB requests | The number of heavy database requests being serviced. |
| count | |
| Task Queue Length | Task Queue Length For Module. |
| For Module | |
| Task Queue Drain | Number of seconds needed to process all tasks for this module by all currently |
| Time Per Module | connected instances. |
| Module Instance | Number of module instances running. |
| Count | |

The statistics output by the modules and collected by monitoring module 305 during operation can be accessed by a capture flow advisor (CF advisor) 309 and an integrated process advisor (IP advisor) 311.

Capture flow advisor 309 is a component configured to analyze statistics output by production modules or collected by monitoring module 305 and apply rules to generate recommendations of changes to optimize the runtime environment for executing the capture flow. According to one embodiment, capture flow advisor 309 can output recommendations to a data store (e.g., a data base), graphical user interface, email message or other message or provide recommendations via another mechanism. According to one embodiment, the recommendations can be accessed via an interface provided by process design tool 308 or an administration module. The CF advisor 309, according to on embodiment, is configured to generate recommendations regarding the number of module instances to be run, the amount of memory, the number of CPUs, number of virtual machines (VMs) and best practices for their setup, or other aspects of the execution environment. For example, if CF advisor 309 determines from the statistics stored by the production modules that a particular production module received more than a threshold number of tasks in a particular time, the CF advisor 309 may generate a recommendation to install more instances of the module. According to one embodiment, the CF advisor 309 can also recommend a number of licenses for a particular module to be purchased/activated at the moment or in in the future (for example, if customer plans to process × times more the same kinds of documents next year). As another example, if the task queue length for a module exceeds a particular size, the CF advisor 309 may generate a recommendation to install more instances of the module type or, for modules that rely on human input (such as human indexing of document), to add more operators. As another example, the CF advisor can apply rules to identify when to upgrade or reconfigure hardware/virtual environment or operating system of the machine on which the production modules execute.

In some embodiments, application of the capture flow advisor rules may include applying machine learning modules or pattern matching. According to one embodiment, capture flow advisor may track trends in the input data to modules and performance to identify correlations. The capture flow advisor may, for example, correlate a decrease in performance of a module to a change in the input documents (e.g., changes in size, format or other characteristics). For example, if the RAM space for picture processing was sufficient for previous input images, but the input image size then increases, the performance of the system may drop due to swapping. The capture flow advisor can identify the degradation and relate it to the input document changes. Further, the capture flow advisor can identify which module experienced degraded performance and recommend increasing RAM in the system running that module.

As another example, a capture flow advisor may analyze performance statistics and determine that a portion of the capture process is particularly efficient for a particular type of document. Based on such a determination, the capture flow advisor can recommend to sort the documents by new criteria or introduce new CF branch (alternative steps) for other kinds of documents.

As a further example, a model may be developed that ties system throughput to external factors (for example week days). Using such a model, a CF advisor may advise some reallocation of the resources (operators, VMs, etc.) based on the current or upcoming state of the external factors. More particularly, the production modules might be geographically distributed. The capture flow advisor can determine the load balancing depending on the time of the day, day of the week, kind of documents, etc. The capture flow advisor may also advise on migration of modules between different locations.

As another example, a capture flow advisor may provide recommendations on the surrounding operating environment. For example, if it is identified that a field in a particular kind of a document often requires re-scan or manual correction, the capture flow advisor may recommend changing the scanner resolution or adjustments to the picture processing algorithm. A capture flow advisor may also use machine learning to produce some user experience recommendations, for example “fill the form clockwise”.

IP advisor 311 is a component that summarizes output by the production modules or collected by monitoring module 305 and creates recommendations for optimizing the capture process as an integrated process. For example, the IP advisor 311 may be programmed with rules to identify bottlenecks in a process or common patterns and recommend changes to a capture flow. According to one embodiment, IP advisor 311 can output recommendations to a data store (e.g., a data base), a graphical user interface, email message or other message or provide recommendations via another mechanism. According to one embodiment, the recommendations can be accessed via an interface provided by process design tool 308 or an administration module.

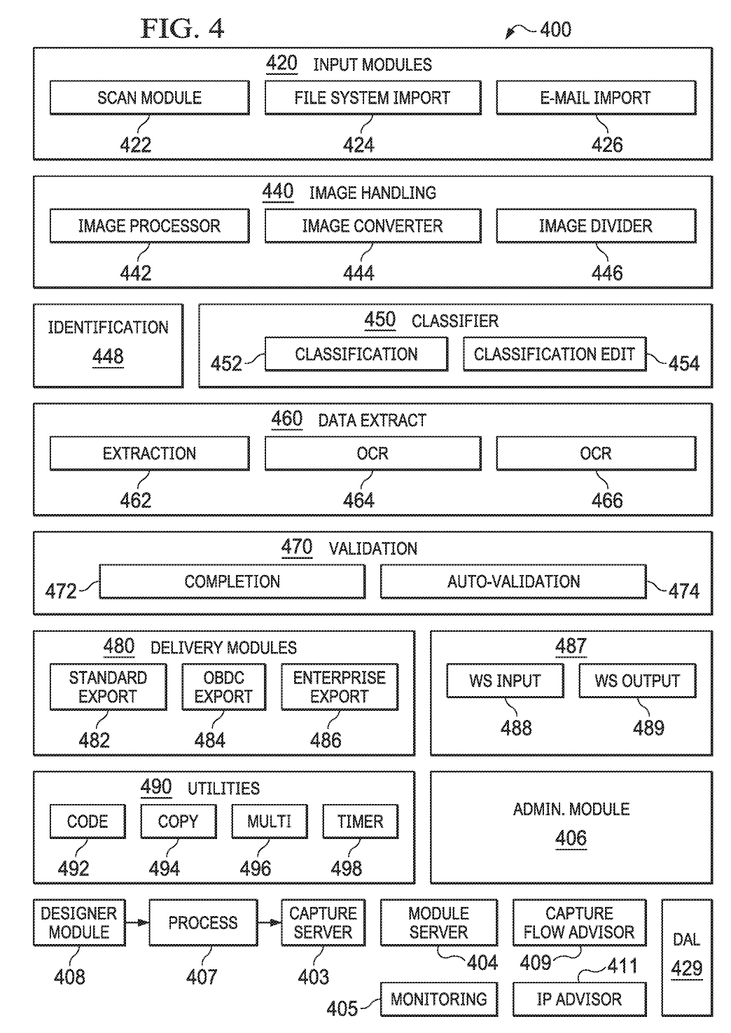

FIG. 4 is a diagrammatic representation of one embodiment of components of a document capture platform 400 that may be implemented in a document processing system, such as document processing system 300. Components of platform 400 may be embodied as computer instructions stored on a non-transitory computer readable medium. The components may execute on one or more host machines and, in some embodiments, multiple instances of a single component may be executed on the same host machine in parallel.

In the illustrated embodiment, components include a capture server 403, a module server 404, an administration module 406, a designer module 408, and production modules including input modules 420, image handling modules 440, identification modules 448, classifier modules 450, extract modules 460, validation modules 470 delivery modules 480, web services modules 487 and utilities 490. The modules comprise executable code. For example, each module may be an EXE module (an application) that can be launched in the operating system of a host machine or a DLL module that can be hosted by a program at a host machine.

The components of platform 400 may run on a single host machine or be distributed on multiple host machines. Capture server 403 executes on a capture server host machine (a capture server machine) and each production module, administration module 406 and designer module 408 executes on a client host machine (client machine). Module server 404 executes on a module server host machine (module server machine) and hosts one or more production modules or provides access to one or more production modules as services. The module server machine may thus be considered a particular type of client machine. In some embodiments, a capture system, such as capture system 302, may comprise one or more capture server machines and one or more module server machines. In some cases, a single host machine may be both a capture server machine and a client machine. Multiple production modules can run on a single client machine, or each can run on a different machine or be otherwise distributed on client machines. In some cases, multiple copies of a production module may run on multiple machines. In other embodiments, multiple instances of the same production module may run in parallel on the same host machine. The components of capture platform 400 may communicate using suitable protocols. For example, according to one embodiment, the components may use TCP/IP to communicate.

Capture server 403, according to one embodiment, is an open integration platform that manages and controls the document capture process by routing document pages and processing instructions to production modules. In particular, capture server 403 ingests a compiled process 407 which comprises instructions for directing capture server 403 to route images and data to the appropriate production modules in a specific order. Compiled process 407 may further comprise processing instructions that are implemented by capture server 403 or forwarded by capture server 403 to the appropriate production module.

The production modules are software programs that perform specific information capture tasks such as scanning pages, enhancing images, and exporting data. Production modules may run remotely from capture server 403 component. Some production modules, referred to as “operator tools”, may require operator input to complete the module processing step specified in the compiled capture process 407 being implemented. Other production modules, referred to as “unattended modules”, are configured to automatically receive and process tasks from capture server 403 without requiring operator intervention to complete the module processing step specified by the compiled capture process 407 being implemented. Module server 404 can make various production modules available as services. In some embodiments, module server 404 is limited to concurrently executing a certain number of instances of each module based on licensing requirements. For example, module server 404 may be limited to a maximum of five concurrent instances of a classification module 452 and three concurrent instances of an extraction module 462. However the number of concurrent instances may be increased by adding licenses.

According to one embodiment, a data access layer (DAL) 429 is provided. The DAL 429 is the programming layer that provides access to the data stored in the various repositories and databases used by platform 400. For example, the DAL 429 can provide an API that is used by modules to access and manipulate the data within the database without having to deal with the complexities inherent in this access.

Input modules 420 comprise modules that are configured to capture documents from a variety of sources. Input modules 420 can create batches from scanned documents, files imported from directories, emails and attachments imported from email servers or documents imported from other sources. Example input modules comprise a scan module 422, file system import module 424 and email import module 426.

Scan modules 422 are production modules configured to create batches and import pages into the batch, automatically creating a batch hierarchy based on detected scanning events. A scan module 422 may support various scanner drivers. In one embodiment, a scan module can use the Image and Scan Driver Set by Pixel Translations of San Jose, Calif., which is an industry standard interface for high performance scanners. Scan modules 422 may provide a user interface that allows operators to create batches and scan or import pages into them, automatically creating a batch hierarchy based on detected scanning events.

File system import modules 424 are configured to watch a directory for new files. When a new file is detected in a specified directory, the file system import module 424 watching the directory creates a new batch based on the process 407. A file system import module 424 may run at intervals as needed. When a module 424 runs, the module 424 imports files found in a watched directory into one or more batches until all the files (or some defined subset thereof) are imported. A module 424 may be configured to locate files in subdirectories. When a file has been successfully imported, the module 424 can remove the file from the watched directory. File system import modules 424 may run unattended as services on a client machines.

E-mail import modules 426 receive documents in the form of e-mail and attachments from mail servers. An e-mail import module 426 is configured to parse an incoming e-mail into parts enabling the various parts of the e-mail message (message body and attachments) to be imported as separated items.

Image handling modules 440 comprise modules configured to enhance, manipulate, and add annotation data to images. Image processor modules 442 are configured to apply image filters to detect content, remove distractions such as holes or lines, adjust colors, improve line quality, and correct page properties using, for example, image processing profiles. Examples of image processing filters include, but are not limited to detection filters, removal filters, color adjustment filters, image quality filters and page correction filters. Detection filters comprise filters to detect features in images, such as barcodes, blank pages, color marks, colorfulness, patch codes. Removal filters comprise filters to remove selected features in an image such as background, black bars, holes and lines. Color adjustment filters comprise filters to adjust overall color, convert specific colors, convert to black and white and invert colors. Page correction filters comprise filters configured to adjust the page, such as filters to crop, deskew, rotate and scale page images.

Image converter modules 444 are configured to convert image files from one format to another.

Image converter modules 444 can be configured implement a variety of conversions, including, for example:

changing image properties including file format, color format and compression;

converting non-image files from a variety of formats to images and PDF files;

converting image files to PDF files;

generating output files of specific file types such as, for example, PDF, TIFF, BMP and other file types;

merging single-page files into multi-page documents;

splitting multi-page documents into single pages;

merging annotations added to images by other modules;

generating thumbnails of pages processed.

Image divider modules 446 are configured to acquire, identify and process multi-page image files. When an image divider module 446 identifies an incoming file as a multi-page image file, the image divider module 446 can split the file into single-page files while preserving the attributes of the original image file.

Identification modules 448 enable operators to assemble documents, classify document pages to page templates, verify and edit values in pre-index fields, check and edit images, flag issues, and annotate pages.

Classifier modules 450 classify documents based on document type. According to one embodiment, classification modules 452 are configured to classify documents automatically by assigning each document to a template (e.g., such as a data entry form as discussed in conjunction with FIG. 3 or other template). Documents that cannot be classified automatically by matching them to templates can be sent to a classification edit module 454.

A classification module 452 may comprise a classification engine that classifies documents using one or more techniques, including, but not limited to:
Full page image analysis: Evaluates and compares an entire image to models stored in each template.
Handwritten detection analysis: Evaluates images to determine the percentage of handwriting they contain. If higher than a predefined threshold, an image is classified as “handwritten”.
Full text analysis: performs OCR and evaluates the resulting text for keywords, pattern matches, or regular expressions that were defined in a template.
High precision anchors: selects a feature of an image based on a similar feature that was demarcated on a model image stored in a template.

Classification edit modules 454 enable operators to manually classify documents that were not classified automatically by a classification module 452. Operators can classify documents by assigning each document to a template. According to one embodiment, classification edit modules 454 are operator modules that operators interact with to successfully process documents. Batches selected for processing during production may open automatically in an interface provided by a classification edit module 454. The interface can provide a window where an operator can complete and correct automatic classification that was performed classification module 452.

Data extract modules 460 are production modules configured to extract data from page images. Extraction modules 462 extract data from each page of a document and combines page-level outputs into a single document. According to one embodiment, extraction modules 462 extract field data into a document object. An extraction module 462 may use multiple techniques to extract data. By way of example, but not limitation, an extraction module 462 can use zonal recognition to extract data from predefined areas of page and free form recognition to extract data from an entire page. An extraction module 462 may include a recognition engine configured to recognize machine print, hand print, checkboxes 1D barcodes, 2D barcodes, signatures (present or not), checks or other features.

Platform 400 may include OCR modules 464. An OCR module 464 can be configured to use one or more OCR engines to perform OCR on images in various formats. Platform 400 can further include OMR modules 466. OMR modules 466 can be configured to recognize optical markings.

Validation modules 470 include modules to validate extracted data. For example, completion modules 472 enable operators to assemble documents, index and validate data, check and edit images, and flag issues. The user interface components that operators see in validation view are determined during module setup and in global configuration options. Document types created in the capture system can determine the appearance and behavior of the data entry form that operators use for indexing and validation. Upon launching a completion module 472, an operator can choose work from the list of batches available for processing. After getting either a single batch or multiple batches, the operator can cycle through each document until all work items have been processed. The types of work items to be addressed for each piece of work may be determined by completion module 472 settings. Platform 400 may further include auto-validation modules 474 configured to validate data against external data or data from other data sources.

Utilities 490 comprise custom code modules 492, copy modules 494, multi modules 496 and timer modules 498. Custom code modules 492 comprise custom code that can be run as an independent step within a process 407. A custom code step can be added to the process like any other module step.

As one example, a code module 492 may provide a Microsoft .NET Framework programming interface or other programming interface that can be used to read and write batch data. A developer accesses this interface by creating a .NET assembly (DLL file) or other appropriate code. The code module's programming environment may also provide access to built-in interfaces. For example, a .NET Code module's programming environment also provides access to built-in .NET Framework interfaces.

A copy module 494 can be configured to automatically copy batches to another capture system, to a local or network directory, to an FTP site or to another destination.

A multi module 496 can allow processes to manipulate the batch tree (e.g., by inserting or deleting nodes) change trigger levels in a process (discussed below) and perform other operations.

A timer module 498 can be configured to trigger other modules to start processing tasks from specified batches at a particular time. During setup, rules are created to specify the conditions under which a timer triggers other modules and the operations the timer module 498 performs during production.

Delivery modules 480 include modules configured to output data to specified destinations. In the illustrated embodiment, delivery modules include standard export modules 482, OBDC export modules 484 and enterprise export modules 486.

Standard export modules 482 can be configured to exports content to emails (HTML/text) and files (CSV, XML, free text, and data file). A single export step can define the batch data to export, the format for the batch data, and the location where the batch data is written. ODBC export modules 484 can be configured to store image data and related values to databases.

Enterprise export modules 486 can be configured to export images and values to enterprise content management system. According to one embodiment, an enterprise export module 486 can be configured to export documents to new or existing objects in the enterprise content management system.

Platform 400 can further include web services (WS) modules 487. WS modules 487 include WS input modules 488 and WS output modules 489. WS input modules function as web service providers, processing requests form external web services consumers. A step of a WS input module 488 can be configured at the beginning or in the middle of a process. When used at the beginning of a process, a WS input module 488 creates new batches as it receives web service requests from external systems. When used in the middle of a process, a module 488 can insert data and files into an existing batch. A WS input module 488 can provide mapping for simple parameters (single values, structures, and arrays) and client-side scripting capabilities to enable processing of more complex parameters.

WS output module 489 serves as a web services consumer, using Internet protocols to access the functionality of external web services providers. A WS output step, if configured, is configured at or near the end of a process, enabling the module to export data that has been processed by other modules. By using a WS output module 489, images, files, and metadata can be extracted from the document capture system to any web-service enabled, third-party system without writing a custom export module.

Administration module 406 is a tool that enables administrators to manage batches, users, processes, licensing, and reports. An administrator can use an administration module 406 to monitor, configure, and control a capture system. An administrator can view and configure aspects of the system relating to, for example:

CaptureFlow definitions (process definitions)

Batch data (in real time as it is processed)

User departments, roles, and permissions

Servers and server groups (for clustered implementations)

Web services configurations

Licensing

In particular, according to one embodiment, a particular installation of platform 400 may be limited in the types and number of instances of modules that can be run based on licensing. Administration module 406 can reconfigure an installed platform 400 to change the types and number of instances permitted.

Designer module 408 provides a centralized development tool for creating, configuring, deploying, and testing the capture system end-to-end. This tool can serve as single point of setup for process design tasks and enables access to capture process design tools. Designer module 408 may include a number tools to enable a variety of design activities such as, for example:
Image Processing: Create profiles with filters that enhance image quality, detect image properties such as barcodes or blank pages, make page corrections such as deskewing and rotating, add and edit annotations on images.
Image Conversion: Create profiles that specify image properties including file format, color format, and compression to convert non-image files to images and images to non-images (for example, TIFF to PDF), merge and split documents and merge annotations added to TIFF images by other modules into the output image.
Recognition: Create recognition projects that identify the templates, base images, and rules for classifying documents.
Document Types: Create a document type for each paper form and associate it with a recognition project. The document type defines the data entry form that the Completion module operators use for indexing and validation. Document type definition can include defining fields and controls, a layout, a set of validation rules, and document and field properties.
Export: Create profiles that specify how data should be exported for capture processes.
Capture Flow Designer: Create and design new capture processes. Each process can comprise a detailed set of instructions directing the capture server 303 to route images and data to the appropriate production modules in a specific order.

The designer module 408 can comprise a capture flow compiler (“CF compiler”) configured to output a capture process 407 to implement a capture flow.

According to one embodiment, a process 407 may provide instructions for processing documents in batches. A module may process all of the batch data at once or the batch data may be separated into smaller work units, for example as discussed above with respect to FIG. 3. According to one embodiment, capture server 403 controls batch processing, forms the tasks, queues tasks (e.g., on the capture server machine) and routes them to available production modules based on the instructions contained in the process 407. Capture server 403 can monitor the production modules and send them tasks from open batches (for example, when a production module has space in a task queue). If multiple machines are running the same production module, the server can apply rules to send the task to a particular instance. The state of a task is manipulated by capture server 403 as well as by the production modules that process it.

When a production module completes a task, it returns the task to the server 403 and starts processing the next task from a task queue located on the module client machine. When the capture server 403 receives the finished task, it includes the batch node of that task in a new task to be sent to the next module as specified in the process 407. Capture server 403 also sends a new task to the module that finished the task if there are additional tasks to be processed by that module. If no production modules are available to process the task, then the server queues the task until a module becomes available. According to one embodiment, server 403 and the production modules work on a “push” basis.

Each task for a process 407 may be self-contained so modules can process tasks from any batch in any order. According to one embodiment, the capture server 403 tracks each task in a batch and saves the data generated during each step of processing. This asynchronous task processing means that the modules can process tasks as soon they become available, which minimizes idle time.

Each production module can output statistics, as discussed in FIG. 3. Platform 400 may also include a monitoring module 405 that monitors the performance of one or more machines running platform 400. For example, a monitoring module may be implemented on a machine running a module server 404. The monitoring module 405 can be configured to collect a variety of performance statistics, including but not limited to, the example statistics included in Table 1 above.

Platform 400 further includes a capture flow advisor (CF advisor) 409 that is configured to analyze statics output by production modules or collected by monitoring module 405 apply rules to generate recommendations for changes to better run a capture flow. CF advisor 409 can output recommendations to a data store (e.g., a data base), a graphical user interface, email message or other message or provide recommendations via another mechanism. According to one embodiment, the recommendations may be accessed via an interface provided by designer module 408.

The CF advisor 409, according to one embodiment, is configured to generate recommendations regarding the number of module instances to be run, the amount of memory, the number of CPUs, number of virtual machines (VMs) and best practices for their setup, or other aspects of the execution environment. For example, if CF advisor 409 determines from the statics stored by the production modules that a particular production module received more than a threshold number of tasks in a particular time, the CF advisor 409 may generate a recommendation to install more instances of the module. According to one embodiment the CF advisor 409 can also recommend a number of licenses for particular module to be purchased/activated at the moment or in in the future (for example, if customer plans to process x times more of the same kinds of documents next year). As another example, if the task queue length for a module exceeds a particular size, the CF advisor 409 may generate a recommendation to install more instances of the module type or, for modules that rely on human input (such as human indexing of document), to add more operators. As another example, the CF advisor 409 can apply rules to identify when to upgrade or reconfigure hardware/virtual environment or operating system of the machine on which the production modules execute. For example, the CF advisor 409 may recommend additional CPUs based on a CPU load factor reaching a threshold CPU load factor or the maximum CPU load factor.

In some embodiments, application of the capture flow advisor rules may include applying machine learning modules or pattern matching. According to one embodiment, capture flow advisor 409 may track trends in the input data to modules and performance to identify correlations. The capture flow advisor 409 may, for example, correlate a decrease in performance of a module to a change in the input documents (e.g., changes in size, format or other characteristics). For example, if the RAM space for picture processing was sufficient for previous input images, but the input image size then increases, the performance of the system may drop due to swapping. The capture flow advisor 409 can identify the degradation and relate it to the input document changes. Further, the capture flow advisor 409 can identify which module experienced degraded performance and recommend increasing RAM in the system running that module.

As another example, a capture flow advisor 409 may analyze performance statistics and determine that a portion of the capture process is particularly efficient for a particular type of document. Based on such a determination, the capture flow advisor 409 can recommend to sort the documents by new criteria or introduce a new CF branch (alternative steps) for other kinds of documents.

As a further example, a model may be developed that ties system throughput to external factors (for example week days). Using such a model, a CF advisor 409 may advise some reallocation of the resources (operators, VMs, etc.) based on the current or upcoming state of the external factors. As a more particular example, the production modules might be geographically distributed and the capture flow advisor 409 can determine the load balancing depending on the time of the day, day of the week, kind of documents, etc. The capture flow advisor 409 may also advise on migration of modules between different locations.

As another example, a capture flow advisor 409 may provide recommendations on the surrounding operating environment. For example, if it is identified that a field in a particular kind of a document often requires re-scan or manual correction, the capture flow advisor 409 may recommend changing the scanner resolution or adjustments to the picture processing algorithm. A capture flow advisor 409 may also use machine learning to produce some user experience recommendations, for example “fill the form clockwise”.

IP advisor 411 is a component that summarizes output by the production modules or collected by monitoring module 405 and creates recommendations for integrated optimization. For example, the IP advisor 411 may be programmed with rules to identify common patterns involving integration and recommend changes to the capture flow based on the application of the capture process as integrated with the larger process. According to one embodiment, IP advisor 411 can output recommendations to a data store (e.g., a data base), graphical user interface, email message or other message or provide recommendations via another mechanism. According to one embodiment, the recommendations can be accessed via an interface provided by designer module 408 or administration module 406.

Attributes may be used store data and pass data from module to module as discussed in conjunction with FIG. 3. Capture server 403 may maintain data to coordinate capture jobs. For example, in one embodiment, capture server 403 maintains batch files and stage files in a local or external file system or database. As batches are processed, attribute data values are updated by capture server 403 with the value data generated by each module.

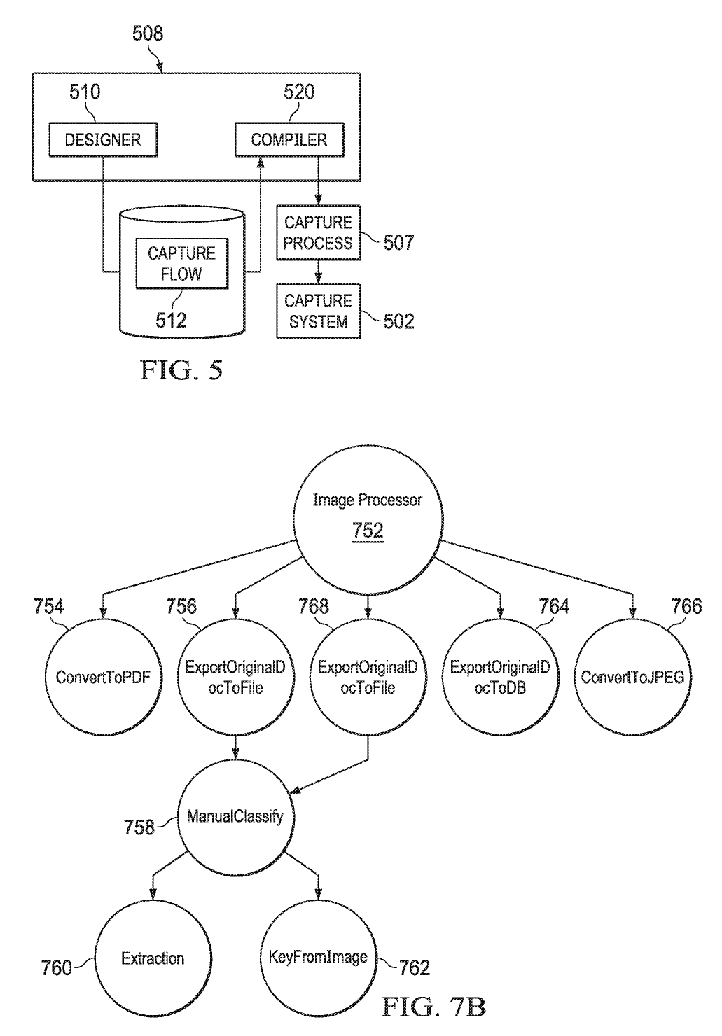

FIG. 5 is a diagrammatic representation of one embodiment of a system for designing and deploying a capture process. The system of FIG. 5 comprises a capture system 502, such as capture system 302 or a system implementing platform 400, and a process design tool 508. Process design tool may execute on a client machine or server machine and can be an example of process design tool 308 or design module 408. Process design tool comprises a capture flow design tool 510 that allows a designer to define a capture flow 512. When the designer is satisfied with the design, a capture flow compiler 520 compiles the capture flow into a capture process 507 that is provided to a capture system 502. Capture process 507 may further comprise processing instructions that are implemented by capture system 502 to implement the capture flow.

According to one embodiment, capture system 502 may comprise an Open Text® Captiva®

Capture server and design tool 508 comprises the Open Text® Captiva® Designer with a capture flow compiler (“CF compiler”) configured to output capture processes as XPP files and adapted to operate as described herein.

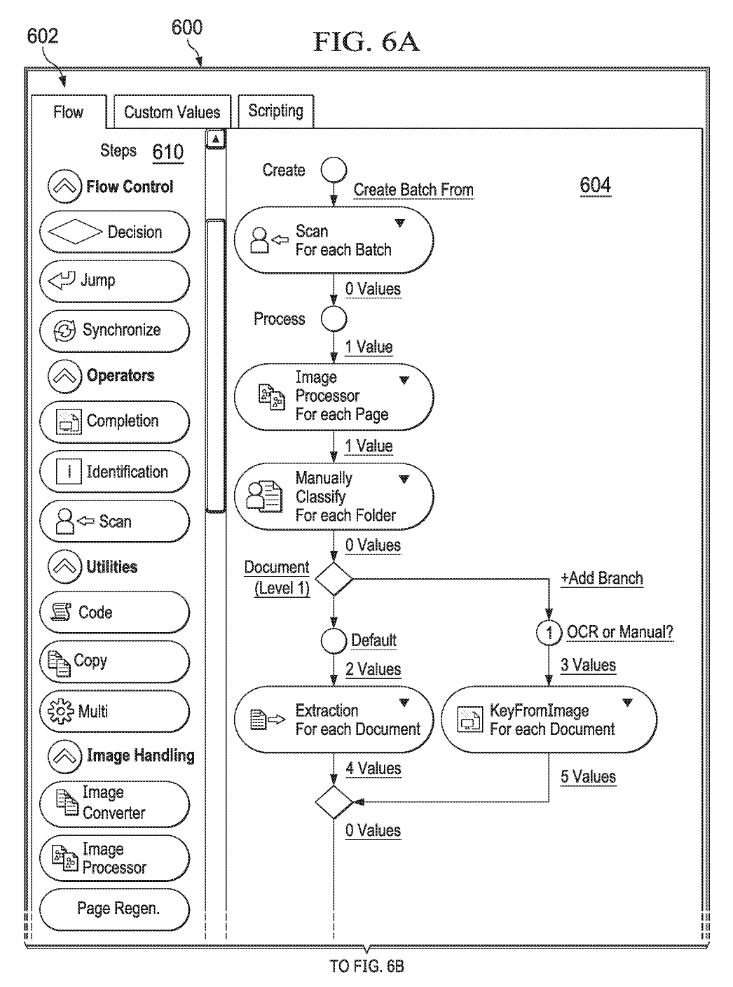

FIG. 6A and FIG. 6B illustrate one embodiment of an interface 600 provided by a process design tool for designing a capture flow. Interface 600 includes capture flow designer tabs 602 that can be used to display a capture flow design interface (shown), a custom values interface to allow a designer to enter custom values and a scripting interface with an embedded script editor that allows the designer to design custom scripts.

The capture flow design interface includes a design area (also referred to as a canvas) 604 and a steps panel 610. Steps panel 610 correspond to configurable processing steps of a capture process. According to one embodiment, steps panel 610 includes steps primitives corresponding to units of executable code (for example, executables or libraries) or other configurable code components installed in a document processing system.

To build a capture flow, the designer drags primitives from the steps panel 610 on the left, onto the canvas 604 on the right, somewhere between the Process and End primitives to define the steps of the capture flow. The capture flow steps can be renamed. In addition to naming the steps, the designer can indicate at what level each step processes, for example, by right-clicking each step and choosing the level option. For example, a scan step can be configured to scan and send documents to a server in batches. An image handling code unit can be applied to each page in the batch. Indexing (automatic or manual classification) can be configured to occur on a per-document basis.

Primitives from step panels 610 can be dragged onto canvas 604 to create a sequence of steps that correspond to configurable code components (e.g., production modules or other code components). The designer can link steps to represent the flow of processing between code components. The designer may include capture flow decisions having default and conditional branches and specify the conditions for selecting a conditional branch.

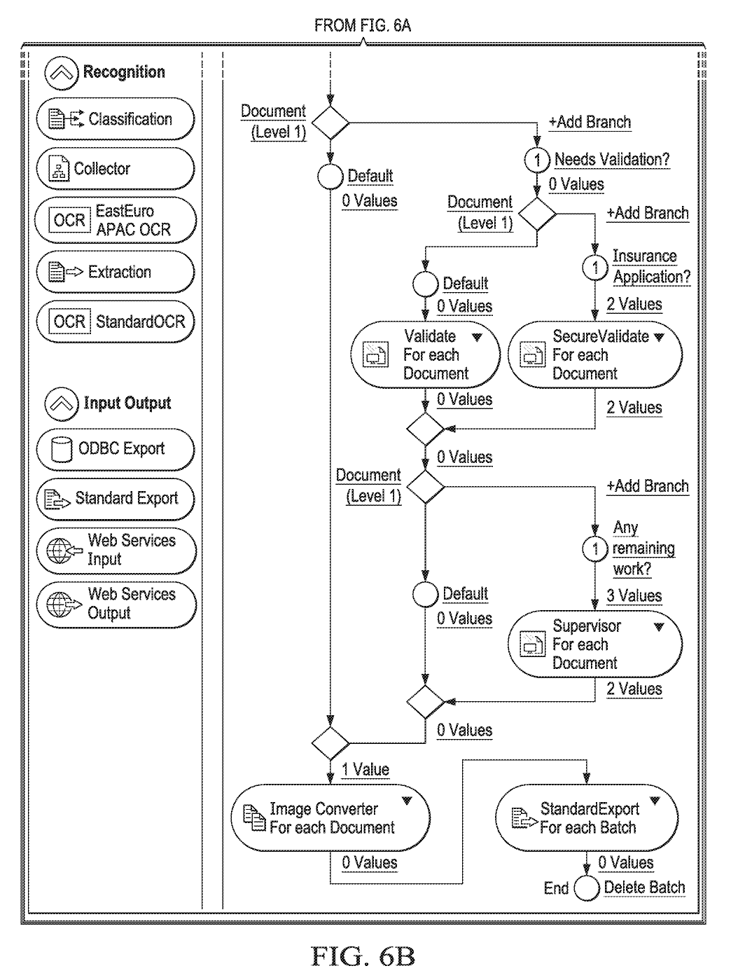

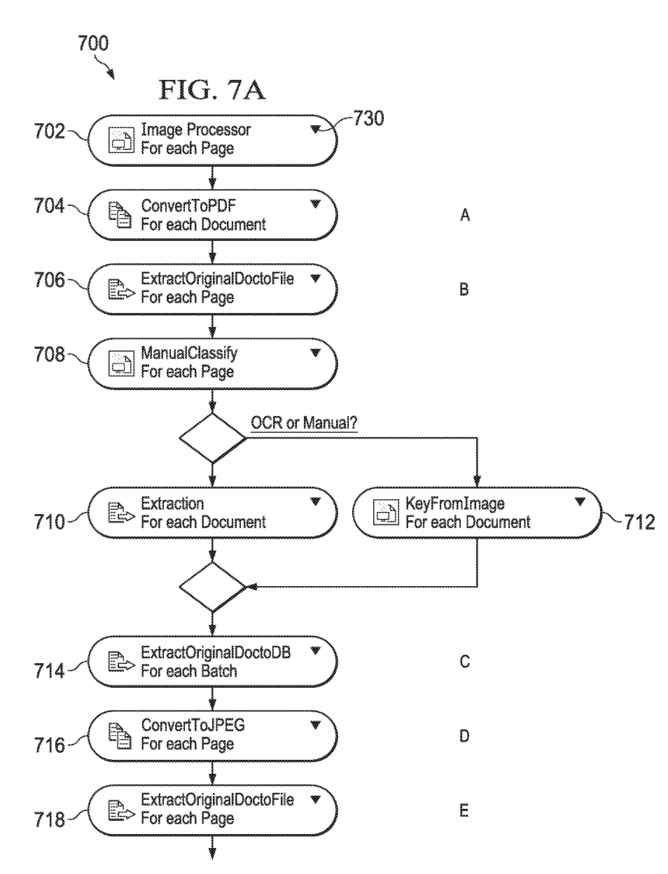

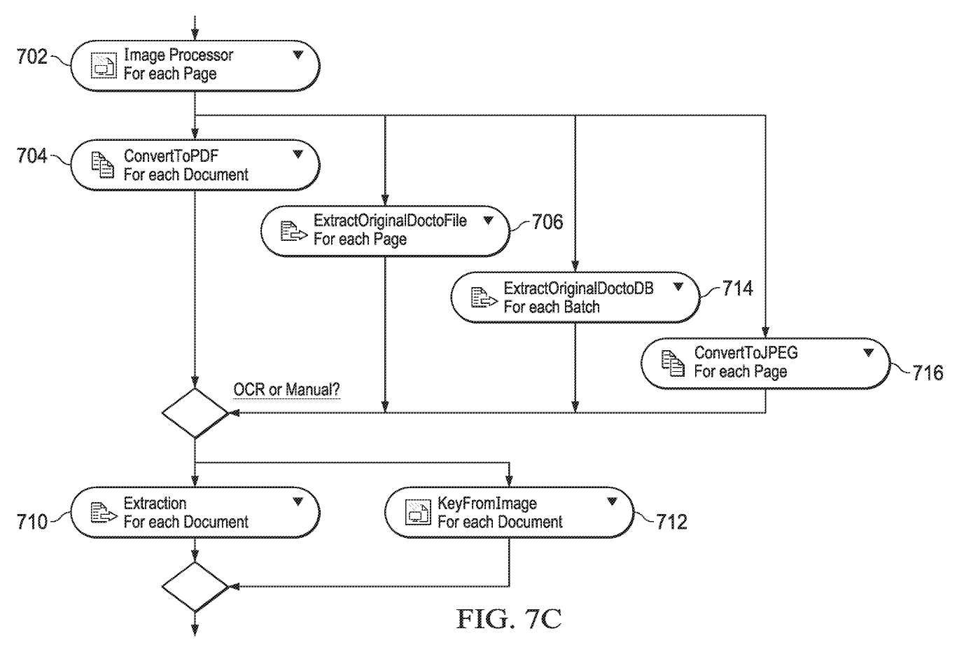

FIG. 7A illustrates one embodiment of a portion of an original capture flow 700 that can be designed in a process design tool. By dropping primitives onto a canvas, the designer creates a capture flow 700 having a sequence of steps. By arranging, linking, and configuring the steps, the designer defines a sequence in which executing codes components will process a document image (or batch of images). According to one embodiment, each capture flow step 702-718 represents a configuration of an identifiable unit of code of a document processing system (such as modules of FIG. 3 or FIG. 4).

For example, by linking image processor step 702 to ConvertToPDF step 704, the capture flow 700 defines that a corresponding image processor code component (for example, a first image handling module 340 of FIG. 3 or image processor module 442 of FIG. 4) will process image files and then the image files will be routed to a ConvertToPDF code component (for example, a second image handling module 340 of FIG. 3 or an image converter module 444 of FIG. 4) for further processing. During execution of a capture process compiled from the capture flow, multiple instances of a module may implement a step (e.g., multiple instances of an image converter module configured according to step 704 may be executed to implement the step).

The designer may also assign what data (e.g., images, attributes or other data) is passed from one step to the next in a capture flow to connect code components. In some embodiments, the process design tool may automatically make at least some of these assignments. For example, when the designer inserts ConvertToPDF step 704 after ImageProcessor step 702, the process design tool can automatically set ConvertToPDF:0.lmagelnput =ImageProcessor:0.ImageOutput. Further, the designer may select the trigger level for a step. For example, in FIG. 7A, the designer has selected that ConvertToPDF works on documents (e.g., a trigger level of 1). This indicates that the document capture system (e.g., document capture system 302) should not trigger a corresponding ConvertToPDF code component to process data for a document until the ImageProcessor code component has provided ImageOutput data values for each page in a document. The designer may also select which statistics the module should output.

The design tool interface can provide tools for configuring the steps. For example, by selecting arrow 730, the designer may be presented with an interface that allows the designer to configure attributes (for example identify input attributes, create custom attributes, identify output attributes, provide step configuration or setup values for attributes) or otherwise provide other information for configuring code elements.

Despite the fact that design tools such as Open Text® Captiva® Designer provide a convenient interface for designing capture flows, the capture flows may still contain inefficiencies. In FIG. 7A, for example, step 706 was accidentally duplicated as step 718. In more complex capture flow examples, particularly where the number of operations exceeds single screen on designer's monitor, such inefficiencies are more likely. The fact that several operators in parallel might edit a capture flow complicates the task.

In addition to inefficiencies due to duplication, other inefficiencies may arise from the ordering of steps. In the example of FIG. 7A, steps 704, 706, 714, 716 and 718 are independent, meaning that, in the group of steps, the input of each step is not dependent on the output of any other step in the group, but may be dependent on the output a step prior to each member of the group (e.g., the output of step 702), yet the arrangement of FIG. 7A indicates that these steps will be executed sequentially. Assume t_{A}, t_{B} t_{C} t_{D} t_{E} are the delays caused by executing code corresponding to steps 704, 706, 714, 716 and 718 while processing the single page. In many cases, millions of pages per year must be processed, so overall delay caused by this flow will be >(t_{A}+t_{B}+t_{C}+t_{D}+t_{E})*10⁶.

Embodiments described herein may eliminate or reduce inefficiencies in a capture flow.

Returning to FIG. 5, a capture flow (CF) compiler 520 provides an automated tool which applies programming language compilation logics to an original capture flow 512 (e.g., a capture flow received from a capture flow designer 510) to reorder operations and optimize an original capture flow 512. For example, CF compiler 520 can perform instruction rescheduling. In one embodiment, CF compiler 520 is configured respect certain dependencies in the original capture flow based on inputs and outputs of each step. Example capture flow optimization rules include, but are not limited to:
Read after Write (“True”): Step 1 outputs a value used later by Step 2. Step 1 must come first.
Write after Read (“Anti”): Step 1 inputs an attribute value that is later output by Step 2.
Step 1 must come first, or it will input the new value instead of the old.
Write after Write (“Output”): Two steps both output data values for the same attribute.
Steps must occur in their original order.

To respect these dependencies, the CF compiler 520 can create a directed graph where each vertex is an instruction and there is an edge from Step 1 to Step 2 if Step 1 must come before Step 2 based on the above-referenced rules. The order of graph vertices and the edges can be determined based on the input and output attributes specified in the original capture flow. FIG. 7B represents a graph for the portion of an original capture flow illustrated in FIG. 7A. Node 752 represents step 702, node 754 represents step 704, node 756 represents step 706, node 758 represents step 708, node 760 represents step 710, node 762 represents step 712, node 764 represents step 714, node 766 represents step 716, node 768 represents step 718.

If a first step and a second step are of the same type and have identical input attributes and output attributes, the steps can be considered duplicates and one of them eliminated. For example, because nodes 756 and 758 are identical, one of the duplicative steps, say step 718, can be eliminated from the capture flow. Furthermore, steps that occur at the same depth of the directed graph can be reordered for parallel execution. FIG. 7C, for example, represents an example of how an optimized flow might look. The duplicated steps are eliminated and the independent steps are parallelized. As such, the duration of the execution of 704, 706, 714, 716 and 718 is limited by the duration of the longest module from 704, 706, 714, 716. CF compiler 520 can compile a capture process 507 based on the optimized capture flow. Thus, if the computing environment has enough processing power, parallelization of the steps may improve the overall throughput. It can be noted, however, that even though steps may be compiled for parallel execution, the capture system may execute parallelized steps in sequence based on the availability of modules, memory, processing power or other runtime factors.

In one embodiment, CF compiler 520 is an ahead-of-time compiler and performs CF optimization work before execution begins. In another embodiment, CF compiler 520 is a just-in-time (JIT) compiler that executes on a capture system (capture system 502) and compiles a capture process 507 when an operator requests to run a process on a batch.

CF Compiler 520 may also gather statistics as document capture system 502 executes a process 507, and use pattern matching and machine learning algorithms in an optimization process. Using an example in which document capture system 502 implements at least a portion of platform 400, the document capture system 502 may have, for example, licenses to concurrently run 20 instances of an image converter module 444 configured to carry out the ConvertToPDF step 704, but only enough licenses to concurrently run 5 instances of an extraction module 462 configured to carry out step 710. When processing a job, this may lead to a buildup in input queues for the instances of module 462. Based on applying rules to various queue statistics collected by a monitoring module 405, capture flow advisor 409 may generate a recommendation to add additional licenses for module 462 or make another recommendation.

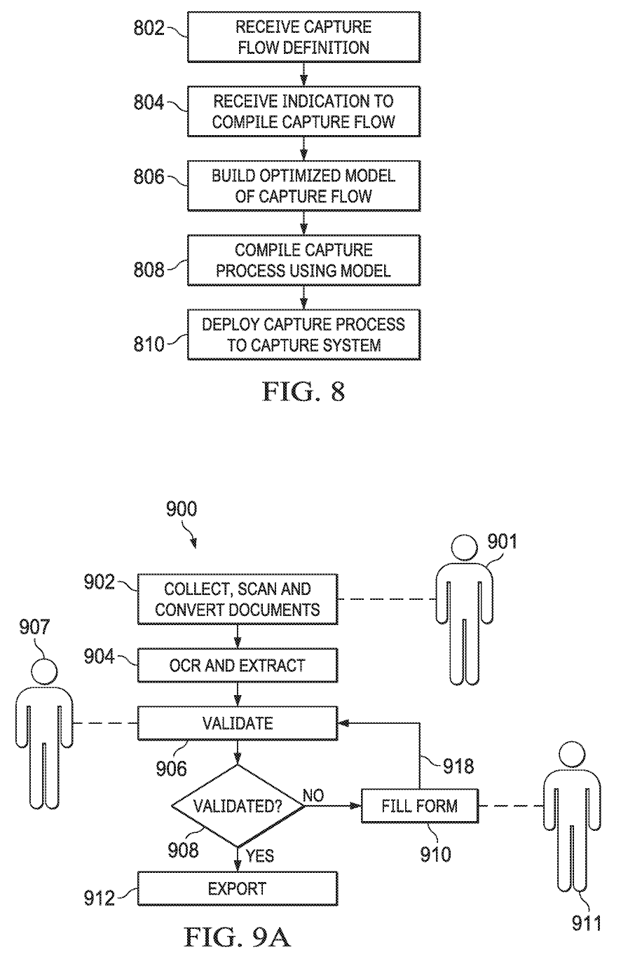

FIG. 8 is a flow chart illustrating one embodiment of a method for processing a capture flow. According to one embodiment, a process design tool receives a capture flow comprising a series of steps with each step comprising a configuration of an identifiable portion of executable code (step 802). The received capture flow includes an indication of an order of the steps and of the connections between steps (e.g., the input and output attributes of each steps). The process design tool receives an indication to compile the capture flow (step 804). The capture flow compiler can build an in-memory model of the capture flow, such as directed graph, with steps as vertices and links between the steps as edges (step 806). The directed model may be built on rules, such as instruction scheduling rules. The capture flow compiler can compile the capture flow into a capture process based on the model (step 808). In compiling the capture process, the capture flow compiler can identify duplicative steps from the capture flow and eliminate the duplicative steps. The capture flow compiler can further identify groups of independent steps and compile the steps in the group as parallel steps. In one embodiment, the capture flow compiler identifies steps occurring at the same depth of a directed graph model as independent steps. The compiled capture flow provides instructions for a document capture system including an order in which modules are to process the tasks, setup attribute values, trigger values, processing instructions for steps. The process design tool can deploy the compiled process to a capture system in a format that is usable by the capture system to implement the process (step 810).

Document capture systems are often integrated with larger processes of an organization, such as business processes. Accordingly, a capture flow may define steps for integrating with a larger process. Such steps, for example, may correspond to configurable code components that require operator input, receive data from systems external to the document capture system or provide data to external systems as part of executing a capture process. In some cases, a capture process may be capable of performing the functions required of it for the larger process, but, in practical application, suffers inefficiencies due some aspect of the larger process. An integrated process advisor (e.g., IP advisor 311, 411) can apply rules, including machine learning models, to statistics collected by production modules or a monitoring module to identify inefficiencies and recommend changes to a capture flow to optimize the capture process as an integrated process.

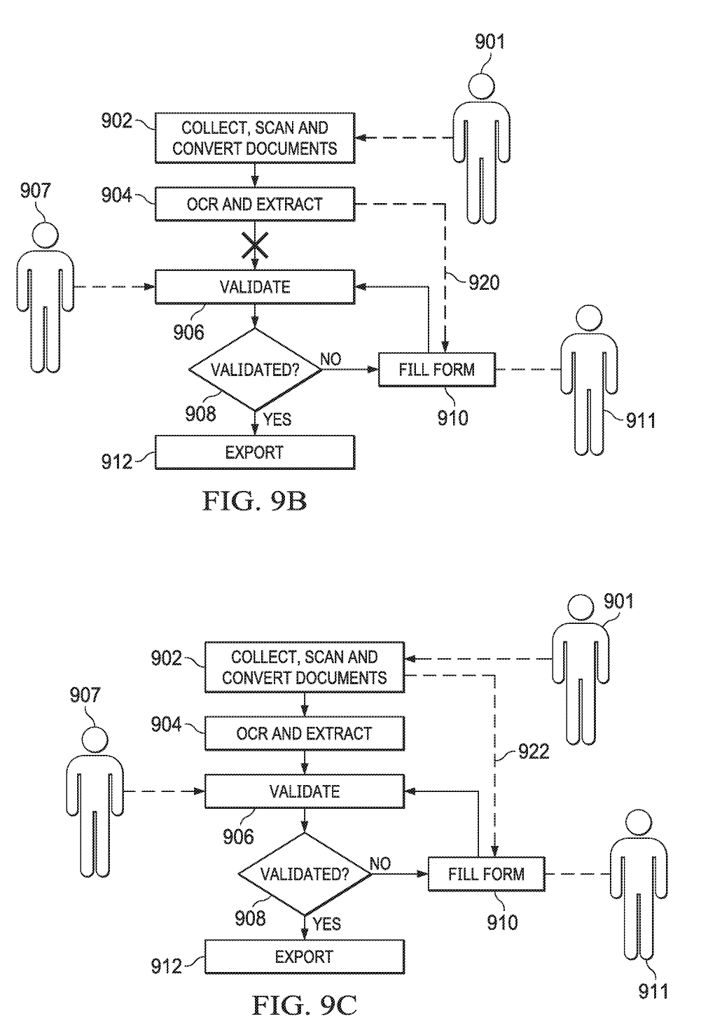

FIG. 9A, for example, is a diagrammatic representation of an example document flow 900 integrated as a portion of a business process. In the illustrated embodiment, several capture flow steps are represented by a single block in document flow 900 for convenience. At collect, scan and convert documents (document flow step 902), paper documents are collected by operators 901 in a first department and scanned into an electronic format. This may involve processing by input modules associated with operators 901 (e.g., instances of a scan module 422) and image handling modules (e.g., instances of an image converter module 444). At document flow step 904, the data is extracted from document images using classifier modules (e.g., instances of a classification module 452) and data extract modules (e.g., an instance of an extraction module 462). The classifier modules may, for example, populate document forms using the data extracted from document images.

At document flow step 906, the document images and data are sent to operators 907 in another department to determine if the forms were filled in correctly. According to one embodiment, the document images and data can be forwarded to validation modules associated with the operators 907 so that the operators 907 can review the documents and extracted fields to validate the forms. For example, the document capture system can forward the document images and forms to instances of a completion module 472 associated with operators 907. If the document capture system determines that a document is validated (document flow step 908), the document capture system can export the document (document flow step 912). For example, if the document capture system receives a signal from the first completion module 472 indicating that a document is validated, the document capture system can provide the document object including the document image and associated document form data to a delivery module 480 for export. If, however, the document is not validated at document flow step 908, the document capture system can forward the document image and data to an operator 911 in another department to perform a fill form (document flow step 910). For example, the document capture system can forward documents that did not pass validation to instances of a validation module associated with operators 911 (e.g., instances of a second completion module 472) that allow operators 911 to review the document images, fill in missing data, modify data or otherwise edit the document forms. When the document capture system receives an indication that an operator 911 has finished editing a form, the document capture system can send the document images and data back to an operator 907 for validation. For example, the document capture system can send the document back to an instance the first completion module 472.

Based on statistics of the flow execution, a number of other decisions may be made. For example, if operators 907 in one region tend to process documents faster, the integrated process advisor may recommend routing documents to completion modules associated with operators in the region first. As another example, if a particular step involving operators results in a bottle neck, the integrated process advisor may recommend additional operators. Other recommendations may include recommendations regarding what equipment is required, what work might be outsourced or other recommendations.

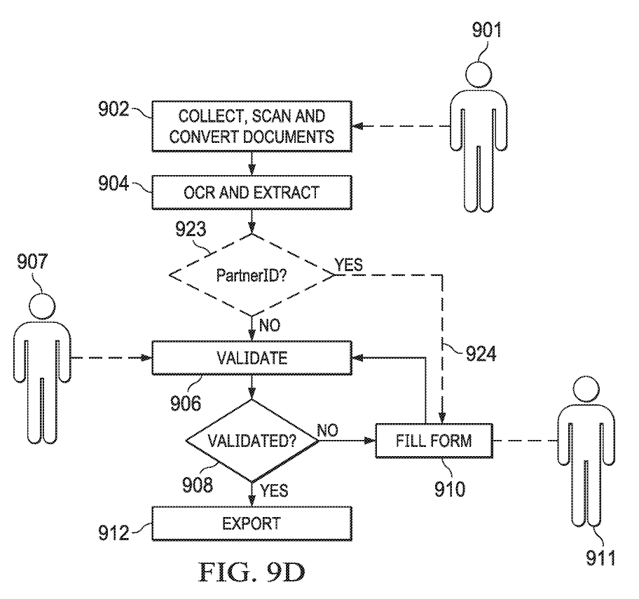

In a particular embodiment, the integrated process advisor can be configured to recommend changes in the capture flow to load balance operators or otherwise make the flow more efficient. FIG. 10 is a flow chart illustrating one embodiment of an integrated process advisor process for recommending changes to a capture flow. At step 1002, the integrated process advisor accesses batch data (including statistics output by modules as attributes) and statistics collected by monitoring module 305 during execution of a capture flow process. In one embodiment, an operator may specify which batch data to analyze. In another embodiment, the integrated process advisor may analyze the batch data based on a pre-configured time window or other criteria.

At step 1004, the integrated process advisor identifies a loop in the capture flow process involving an operator (or other process integration point). In one embodiment, integrated process advisor identifies capture process decisions that determine the routing of images or associated data to the next production module and determines if a capture process decision is a capture process loop decision in which one of the decision branches resulted in the images or associated document data in the batch looping through a capture process step that required operator input. For example, the integrated process advisor determines if a decision branch created at a decision includes a capture process step corresponding to a code module that received operator input to complete a task, where the output of the capture process steps in the branch loops back to the decision. For example, the integrated process advisor can determine that flow 900 includes decision 908 that includes a branch that results in loop 918 comprising loop steps 910 and 906 implemented by completion modules. The integrated process advisor may also identify document flow step 906 as the loop decision input step (the step that produced the output on which the loop decision was made).

Note that according to one embodiment, capture flow decisions are identifiable portions of the capture flow process that correspond to decision primitives in the capture flow. The integrated process advisor may traverse the compiled capture process that was used to process a batch to identify decisions and determine if a particular decision resulted in a loop involving a stage utilizing particular types of modules that require operator input. For example, the integrated process advisor can traverse the compiled capture process to identify decisions that result in looping through classification edit stages or validation stages.

At step 1006 the integrated process advisor can analyze the data to determine how many times each document in a historical batch (or set of batches) processed by the capture flow process went through the loop. For example, the integrated process advisor may access the batch data to determine how many times each document went through each step in the loop. Further, the integrated process advisor can access and analyze the statistics output by each stage to determine a measure of how long each step takes on average.

According to one embodiment, the integrated process advisor can determine a loop decision input step processing time corresponding to a loop decision input step. For example, the integrated process advisor may analyze the operator statistics or other statistics associated with tasks in a batch to determine that, on average, it took modules implementing document flow step 906, which is dependent on input by operators 907, ‘x’ amount of time to complete a task (e.g., process each document).

The integrated process advisor may also determine a loop processing time corresponding to the amount of time processing by the other loop steps took to process documents in the batch. For example, the integrated process advisor may analyze the operator statistics or other statistics associated with tasks in a batch to determine that, on average, it took modules implementing document flow step 910, which is dependent on input from operators 911, ‘z’ amount of time to complete a task (e.g., process each document). Note that if the loop included additional steps, the loop processing time may include an aggregate time to complete the loop processing steps.

In some embodiment, the loop processing time does not include the loop input step processing time.

Moreover, the integrated process advisor can determine from the batch file the percentage ‘p’ (or other measure) of documents in the batch that were looped (e.g., p1 is the percentage of documents in the historical batches being analyzed that went through the loop at least once, p2 is the percentage of documents that went through the loop at least twice and so on).

At step 1008, the integrated process advisor determines if the capture process would have been more efficient if all the documents in the batches being evaluated had been routed to a loop step after the loop decision before being routed to the loop decision input step. For example, the integrated process advisor can determine if it would have been more efficient if all the documents had been routed to document flow step 910 before document flow step 906.

Using the example of FIG. 9A, the amount of time to go through the loop steps can be represented as:

x+p1(z+x)+p2(z+x) . . .pn(z+x)

If the capture flow advisor determines based on processing the historical batch data and statistics that (z+x)<x+p1(z+x)+p2(z+x) . . . pn(z+x), then it would have been more efficient, on the whole, to have routed all the documents to document flow step 910 before document flow step 906 and the integrated process advisor can recommend a recommended path (step 1010) such as path 920 illustrated in FIG. 9B. The integrated process advisor may recommend, for example, connecting the output of the step prior to the loop decision step 906 to the loop step 910 rather than document flow step 906 (e.g., recommend that the output of the classifier module step be connected to the capture flow step 910 corresponding to the validation module for operators 911). The recommended paths may be sent to a designer module for display to a designer when the designer selects to view the capture flow that was compiled into the compiled capture process that was used to process the historical batches. The capture flow with the recommended path may be compiled into an updated capture process.

While in the above example, integrated process advisor recommends connecting the output of step 904 to step 910 to create the recommended path, various process optimization rules may be applied to determine which step prior to the loop decision to connect to the loop step after the loop decision. As one example, integrated process advisor may include a rule that if operators at the loop step had to edit a threshold amount of data in each document form that was looped, the recommended path should skip any OCR or extract steps prior to the loop step. For example, the integrated process advisor may analyze the statistics to determine that on average, operators 911 must enter or edit 90% of the fields in the documents. This may indicate that the paper documents are of especially low quality and that OCR and extract step 904 delays execution while providing little benefit. If the threshold is 70%, the integrated process advisor may recommend path 922 (e.g., recommend that the output of the classifier module step be connected to the capture flow step corresponding to the validation module for operator 911). If, on the other hand, the threshold is 95%, the integrated process advisor may recommend path 922 of FIG. 9C (e.g., recommend that the output of the data extract step be connected to the input of the capture flow step corresponding to the validation module for operator 911). Thus, various rules may be applied to determine which step prior to a loop decision the integrated process advisor should recommend connecting to the loop step at step 1010.

If the integrated process advisor determines that it is not more efficient to route the documents to another loop step before the loop decision input step (e.g., it not more efficient to route all the documents to step 910 before step 906), the integrated process advisor may determine the features of documents that looped (step 1012) and determine features of the documents that correlate to documents having been looped (step 1012). The features may correspond to an output of a capture process step prior to the loop decision input step. The integrated process advisor may recommend inserting a decision to allow documents having the determined features to be routed to a loop step prior to the loop input step (step 1014). To provide an example, say that in analyzing the attributes of documents processed in the historical batches, the integrated process advisor determines that every document that was looped through loop 918 included a field for “partner ID”. This may have occurred because only operators 911 have access to a database needed to validate the partner ID field data. The integrated process advisor may identify this pattern based on the attributes output for each document by the module(s) that implemented document flow step 904. The integrated process advisor may recommend a capture flow decision to selectively connect the output of the extract step 904 to step 910. The recommended decision may be provided to a designer module so that when a designer opens the capture flow that was compiled into the capture process from which the recommendation was created, the capture flow will include the recommended decision. For example, the integrated process advisor may add a process primitive for a recommended decision 923 (FIG. 9D) to the capture flow. In this example, if the capture flow with the recommended decision 923 is compiled and the resulting capture process executed, documents having a partner ID attribute output in step 904 are automatically routed to step 910 (e.g., the output of step 904 for such documents takes path 924 of FIG. 9D). Note that while only a single attribute is used in the foregoing example, the integrated process advisor may determine a pattern based on multiple attributes to recommend a capture flow decision. Moreover, while the foregoing example used the presence of an attribute as a feature, an integrated process advisor may also determine features correlating to a document being looped based on specific attribute values.

As another example, the integrated process advisor may analyze the presence or absence of attributes or the attribute values associated with each document after one or more steps to build a model (e.g., via machine learning) of the documents in which the dependent variable of the model is whether the document went through the loop and recommend a capture flow decision implementing the model. Such a model can be periodically retrained so that the integrated process advisor becomes increasingly more accurate or dynamically changes as more recent data suggests different recommendations.

In any event, the integrated process advisor may be configured to analyze the statistics of a capture flow to make recommendations, based on rules, to change the capture flow for future batches to more efficiently process the documents. In a particular embodiment, the rules are selected to improve load balancing, which may be important in case if operators associated with a particular step are overloaded compared to operators associated with another step.

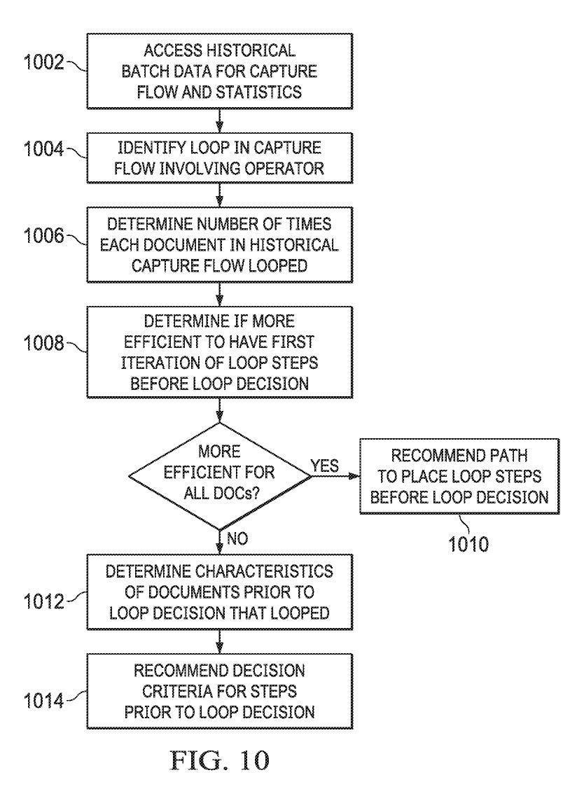

FIG. 11 depicts a diagrammatic representation of a distributed network computing environment where embodiments disclosed herein can be implemented. In the example illustrated, network computing environment 2000 includes network 2005 that can be bi-directionally coupled to client computer 2012, designer computer 2015 and capture system 2002. Capture system 2002 comprises a capture server computer 2003 and a module server computer 2004. Computer 2003 can be bi-directionally coupled to data store 2030. Network 2005 may represent a combination of wired and wireless networks that network computing environment 2000 may utilize for various types of network communications known to those skilled in the art. In one embodiment, computer 2012 may capture images and provide the images to capture system 2002, which recognizes and extracts information from the images as discussed above. The information extracted from the images may be classified and otherwise interpreted and provided to backend systems.

For the purpose of illustration, a single system is shown for each of computer 2003, 2004, 2012 and computer 2015. However, with each of computer 2003, 2004, 2012 and 2015, a plurality of computers (not shown) may be interconnected to each other over network 2005. For example, a plurality of computers 2003, a plurality of computers 2004, a plurality of computers 2012 and a plurality of computers 2015 may be coupled to network 2005. Computers 2012 may include data processing systems for communicating with computer 2003 and/or 2004. Computers 2015 may include data processing systems for individuals whose jobs may require them to design capture processes implemented by capture system 2002.

Capture server computer 2003 can include central processing unit (“CPU”) 2020, read-only memory (“ROM”) 2022, random access memory (“RAM”) 2024, hard drive (“HD”) or storage memory 2026, input/output device(s) (“I/O”) 2028 and communication interface 2029. I/O 2028 can include a keyboard, monitor, printer, electronic pointing device (e.g., mouse, trackball, stylus, etc.), or the like. Communications interface may include a communications interface, such as a network interface card, to interface with network 2005. Computer 2004 may be similar to computer 2003 and can comprise CPU 2031, ROM 2032, RAM 2034, HD 2036, I/O 2038 and communications interface 2039. Computers 2003, 2004 may include one or more backend systems configured for providing a variety of services to computers 2012 over network 2005. These services may utilize data stored in data store 2030. According to one embodiment, server computer 2003 runs a capture server and computer 2004 runs a module server hosting at least one production module, a monitoring module, a capture flow advisor and an integrated process advisor.

Computer 2012 can comprise CPU 2040, ROM 2042, RAM 2044, HD 2046, I/O 2048 and communications interface 2049. I/O 2048 can include a keyboard, monitor, printer, electronic pointing device (e.g., mouse, trackball, stylus, etc.), or the like. Communications interface 2049 may include a communications interface, such as a network interface card, to interface with network 2005. Computer 2015 may similarly include CPU 2050, ROM 2052, RAM 2054, HD 2056, I/O 2058 and communications interface 2059. According to one embodiment, client computer 2012 runs at least one production module, such as an input module, and designer computer 2015 runs a process design tool.

Each of the computers in FIG. 11 may have more than one CPU, ROM, RAM, HD, I/O, or other hardware components. For the sake of brevity, each computer is illustrated as having one of each of the hardware components, even if more than one is used. Each of computers 2003, 2004, 2012 and 2015 is an example of a data processing system. ROM 2022, 2032, 2042, and 2052; RAM 2024, 2034, 2044 and 2054; HD 2026, 2036, 2046 and 2056; and data store 2030 can include media that can be read by CPU 2020, 2030, 2050, or 2060. Therefore, these types of memories include non-transitory computer-readable storage media. These memories may be internal or external to computers 2003, 2004, 2012, or 2015.

Portions of the methods described herein may be implemented in suitable software code that may reside within ROM 2022, 2032, 2042, or 2052; RAM 2024, 2034, 2044, or 2054; or HD 2026, 2036, 2046, or 2056. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. A “computer-readable medium” may be any type of data storage medium that can store computer instructions that are translatable by a processor. Examples of computer-readable media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like. Data may be stored in a single storage medium or distributed through multiple storage mediums, and may reside in a single database or multiple databases (or other data storage).

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit CPU or other processor, memory (e.g., primary or secondary memory such as RAM, ROM, HD or other computer readable medium for the persistent or temporary storage of instructions and data) and an input/output (“I/O”) device. The I/O device can include a keyboard, monitor, printer, electronic pointing device (for example, mouse, trackball, stylus, etc.), touch screen or the like. In embodiments, the computer has access to at least one database on the same hardware or over the network.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise. Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the figures can also be implemented in a more separated or integrated manner, or even removed or rendered as inoperable in certain cases, as is useful in accordance with a particular application. Additionally, any signal arrows in the figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

In the foregoing specification, the invention has been described with reference to specific embodiments. However, one of ordinary skill in the art appreciates that various modifications and changes can be made without departing from the scope of the invention. Accordingly, the specification, including the Summary, Abstract and figures are to be regarded in an illustrative rather than a restrictive sense, and all such modifications are intended to be included within the scope of invention.

What is claimed is:

1. A system comprising:
a network;
a document processing system coupled to the network, the document processing system configured with a plurality of configurable code modules executable to execute a compiled capture process that implements a capture flow to convert source documents into document images and associated document attributes, the document processing system comprising:
a communications interface;
a processor coupled to the communications interface; and
a non-transitory computer readable medium coupled to the processor, the non-transitory computer readable medium storing a set of computer executable instructions comprising instructions executable to:
monitor a machine executing the compiled capture process to collect performance statistics related to execution of the compiled capture process; and
apply defined capture flow optimization rules to the performance statistics and generate and output runtime environment recommendations based on the application of the rules.

2. The system of claim 1, wherein the set of computer executable instructions comprises instructions executable to:
determine a central processing unit (CPU) usage that occurred during execution of the compiled capture process and generate a recommendation to add an addition CPU based on the determined CPU usage.

3. The system of claim 2, wherein the performance statistics include an amount of time a software component executed in an elapsed time.

4. The system of claim 1, wherein the performance statistics includes a task queue length for a corresponding module of the plurality of configurable code modules and wherein the set of computer executable instructions comprise instructions executable to generate a recommendation to install additional instances of a module type of the corresponding module based on a determination that the task queue length exceeded a threshold.

5. The system of claim 1, wherein the performance statistics includes a task queue length for a corresponding module of the plurality of configurable code modules and wherein the set of computer executable instructions comprise instructions executable to generate a recommendation to add additional operators based on a determination that the task queue length exceeded a threshold.

6. The system of claim 1, wherein the set of computer executable instructions are further executable by the processor to recommend a change to the capture flow based on the application of the defined capture flow optimization rules to the performance statistics.

7. The system of claim 1, wherein the set of computer executable instructions are further executable by the processor to:
access historical batch data created during execution of the compiled capture process;
identify a loop back to a decision that includes a step that corresponds to a module that requires operator input to complete a task;
determine a number of documents that looped through the loop during execution of the compiled capture process, a loop decision input step processing time for a loop decision input step and a loop processing time;
determine whether execution of the compiled capture process would have been more efficient had an output of a step prior to a loop decision input step been connected to a loop step based on the loop decision input step processing time, loop processing time and the number of documents that looped through the loop;
based on a determination that execution of the compiled capture process would have been more efficient had the output of the step prior to the loop decision input step been connected to the loop step, generate a recommended change to the capture flow that was compiled into the compiled capture process; and
present the recommended change in a graphical representation of the capture flow.

8. The system of claim 7, wherein presenting the recommended change in the graphical representation of the capture flow comprises presenting a representation of a recommended path from the step prior to the loop decision input step to the loop step.

9. The system of claim 8, wherein the set of computer executable instructions are further comprises instructions executable to recompile the capture flow using the recommended path and redeploy the capture flow to the document processing system.

10. A computer program product comprising a non-transitory computer readable medium storing a set of computer executable instructions, the set of computer executable instructions comprising instructions executable to:
monitor, during execution of a compiled capture process that implements a capture flow to convert source documents into document images and associated document attributes, a machine of a document processing system configured with a plurality of configurable code modules executable to execute the compiled capture process to collect performance statistics related to execution of the compiled capture process; and
apply defined capture flow optimization rules to the performance statistics and generate and output runtime environment recommendations based on the application of the rules.

11. The computer program product of claim 10, wherein the set of computer executable instructions comprises instructions executable to:
determine a central processing unit (CPU) usage that occurred during the execution of the compiled capture process and generate a recommendation to add an additional CPU based on the determined CPU usage.

12. The computer program product of claim 11, wherein the performance statistics include an amount of time a software component executed in an elapsed time.

13. The computer program product of claim 10, wherein the performance statistics includes a task queue length for a corresponding module of the plurality of configurable code modules and wherein the set of computer executable instructions comprises instructions executable to generate a recommendation to install additional instances of a module type of the corresponding module based on a determination that the task queue length exceeded a threshold.

14. The computer program product of claim 10, wherein the performance statistics includes a task queue length for a corresponding module of the plurality of configurable code modules and wherein the set of computer executable instructions comprises instructions executable to generate a recommendation to add additional operators based on a determination that the task queue length exceeded a threshold.

15. The computer program product of claim 10, wherein the set of computer executable instructions are further executable to recommend a change to the capture flow based on the application of the defined capture flow optimization rules to the performance statistics.

16. The computer program product of claim 10, wherein the set of computer executable instructions are further executable to:
access historical batch data created during execution of the compiled capture process;
identify a loop back to a decision that includes a step that corresponds to a module that requires operator input to complete a task;
determine a number of documents that looped through the loop during execution of the compiled capture process, a loop decision input step processing time for a loop decision input step and a loop processing time;
determine whether execution of the compiled capture process would have been more efficient had an output of a step prior to a loop decision input step been connected to a loop step based on the loop decision input step processing time, loop processing time and the number of documents that looped through the loop;
based on a determination that execution of the compiled capture process would have been more efficient had the output of the step prior to the loop decision input step been connected to that loop step, generate a recommended change to the capture flow that was compiled into the compiled capture process; and
present the recommended change in a graphical representation of the capture flow.

17. The computer program product of claim 16, wherein presenting the recommended change in the graphical representation of the capture flow comprises presenting a representation of a recommended path from the step prior to the loop decision input step to the loop step.

18. The computer program product of claim 17, wherein the set of computer executable instructions are further executable to recompile the capture flow and deploy the capture flow to the document processing system.

19. A system comprising:
a network;
a document processing system coupled to the network, the document processing system configured with a plurality of configurable code modules executable to execute a compiled capture process that implements a capture flow to convert source documents into document images and associated document attributes, the document processing system comprising:
a communications interface;
a processor coupled to the communications interface; and
a non-transitory computer readable medium coupled to the processor, the non-transitory computer readable medium storing a set of computer executable instructions comprising instructions executable to:
monitor a machine executing the compiled capture process to collect performance statistics related to execution of the compiled capture process;
traverse the compiled capture process to identify a decision branch that creates a loop that includes a step that corresponds to a configurable code module that requires operator input to complete a task;
determine, based on the collected performance statistics, whether execution of the compiled capture process would have been more efficient had an output of a step prior to a loop decision input step been connected to a loop step;
based on a determination that the compiled capture process would have been more efficient had the output of a step prior to the loop decision input step been connected to the loop step, generate a recommended change to the capture flow; and
present the recommended change in a graphical representation of the capture flow.

20. The system of claim 19, wherein the set of computer executable instructions comprises instructions executable to determine a number of documents that looped through the loop during execution of the compiled capture process, a loop decision input step processing time for a loop decision input step and a loop processing time and the determination is based on the number of documents that looped through the loop during execution of the compiled capture process, the loop decision input step processing time for the loop decision input step and the loop processing time.

21. The system of claim 19, wherein presenting the recommended change in the graphical representation of the capture flow comprises presenting a representation of a path from the step prior to the loop decision input step to the loop step.

22. The system of claim 19, wherein the set of computer executable instructions further comprises instructions executable to recompile the capture flow and deploy the capture flow to the document processing system.
